(19) United States
(12) Patent Application Publication
(10) Pub. No.: US 2005/0064350 A1
(43) Pub. Date: Mar. 24, 2005

(54) Photothermographic material and image forming method

(76) Inventor: Takayoshi Oyamada, Kanagawa (JP)

Correspondence Address: TAIYO CORPORATION, 2111 JEFFERSON DAVIS HIGHWAY, #412, NORTH, ARLINGTON, VA, 22202, US

(21) Appl. No.: 10/653,967

(22) Filed: Sep. 4, 2003

(30) Foreign Application Priority Data
Sep. 6, 2002 (JP) 2002-261279

(51) Int. Cl. G03C 5/16

(52) U.S. Cl. 430/619

(57) ABSTRACT

The present invention provides a photothermographic material including on one surface thereof a photosensitive silver halide, a non-photosensitive organic silver salt, a reducing agent and a binder, and satisfying a relationship of image tone defined by Expression (1):
(a*₁₂₁ₜ−a*₁₁₇ₜ)²+(b*₁₂₁ₜ−b*₁₁₇ₜ)²<2, (1)
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), the values occurring at an optical density of 1.2; and t represents a duration (sec) required to attain a maximum density when the material has been exposed to sufficient light for producing Dmax and is developed at 121° C. The invention also provides an image forming method using the photothermographic material.

### CROSS-REFERENCE TO RELATED APPLICATION

This application claims priority under 35 USC 119 from Japanese Patent Application No. 2002-261279, the disclosure of which is incorporated by reference herein.

### BACKGROUND OF THE INVENTION

1. Field of the Invention

The present invention relates to a photothermographic material and an image forming method. More specifically, the invention relates to a photothermographic material and an image forming method which do not generate developing ununiformity but provide stable image tones.

2. Description of Related Art

Recently in the field of films for medical diagnosis, reduction in the volume of processing waste fluids has been strongly desired from the standpoints of environmental protection and economy of space. Thus, there is a need for technologies relating to photothermographic materials as films for medical diagnosis or photographic films for plate-making which may be efficiently exposed by a laser image setter or a laser imager to form clear black images having high resolution and sharpness. These photothermographic materials are advantageous in providing customers with a thermal processing system that does not need liquid-type processing solutions, and which is simple and not harmful to the environment.

Although there is also a need for the same technologies in the field of general image forming materials, particularly in the field of medical diagnosis, which requires detail depiction, high quality images excellent in sharpness and granularity are needed and blue black image tone is desired for ease of diagnosis. Currently, various types of hard copy systems using pigments and dyes, such as, ink jet printers and electrophotographic systems, are widely used as conventional imaging systems. However, satisfactory systems for outputting images for use in medical diagnosis have never been developed.

Thermally developable image forming systems using organic silver salts are described, for example, in U.S. Pat. Nos. 3,152,904 and 3,457,075, and in “Thermally Processed Silver Systems” Imaging Processes and Materials written by B. Shely, Neblette, 8th Ed., edited by J. Sturge, V. Walworth & A. Shepp, pp. 2, 1996, the disclosures of which are incorporated herein by reference. In general, photothermographic materials have a photosensitive layer (image-forming layer) produced by dispersing a catalytically active amount of a photocatalyst (e.g., silver halide), a reducing agent, a reducible silver salt (e.g., organic silver salt), and optionally a toning agent for adjusting silver color tone, in a binder matrix. Photothermographic materials of this type (dry-type) are, after having been imagewise exposed, heated to an elevated temperature (for example, 80° C. or higher) to form black silver images through a redox reaction between a reducible silver salt (serving as an oxidizing agent) and a reducing agent. The redox reaction is accelerated by catalytic action of latent images which have been formed on silver halides by exposure. This technique is disclosed in many references, such as U.S. Pat. No. 2,910,377 and Japanese Patent Application Publication (JP-B) No.43-4924, and as a result, Fuji Medical Dry Imager FM-DP L which utilizes the photothermographic material is commercially available as an image-forming system for use in the medical field. Photothermographic material utilizing an organic silver salt is produced by applying a coating liquid containing the silver salt dissolved in a solvent followed by drying, or by applying an aqueous coating liquid containing microparticles of a water dispersible hydrophobic polymer as a main binder followed by drying. The latter method may be implemented using simple manufacturing equipment since a step of recoverying the solvent is not necessary, and this method is advantageous in view of mass-production.

Photothermographic material having the aforementioned characteristic features has conventionally been intended to provide the same level of black silver images as can be obtained with wet-type development. Although the photothermographic material has been improved technically, it has not yet attained sufficiently stable black silver images under various development processing conditions. For example, minute variations arise at different places in a 20×12 inch sized sheet. Even if the difference in such variations cannot be detected using a densitometer, it can be visually perceived as unuvenness in density, and hence such images are unusable in medical diagnosis. Thus, there is a need in the art for photothermographic materials having an even image density. Further, when a number of image recording materials are sequentially thermally developed, a difference arises in image tones between the materials processed initially and those processed later, or alternatively, a difference arises in image tones between those processed in the morning and those processed in the afternoon; thus there is a need in the art for improved evenness in image tones over time.

In order to meet the demands, for example, of improving development processing ability and making the apparatus compact, a prior proposed solution involved rapid thermal development in a short period of time (see, for example, Japanese Patent Application Laid-Open (JP-A) No. 2001-330921, column Nos. 0008 to 0013). However., the problems of developing ununiformity and unstable image tones generated during continuous processing have become more sever. In particular, it has been found that these problems were particularly noticiable when rapid development was carried out (e.g., a developing duration of 15 sec or less), which still poses a problem when conducting rapid development processing.

### SUMMARY OF THE INVENTION

Accordingly, it is an object of the present invention to provide an improved photothermographic material and an image forming method that may always form images exhibiting stable tones.

The invention provides a photothermographic material which comprises a support having on at least one surface thereof a photosensitive silver halide, a non-photosensitive organic silver salt, a reducing agent and a binder, and satisfies a relationship of image tone defined by the following Expression (1):
(a*₁₂₁ₜ−a*₁₁₇ₜ)²+(b*₁₂₁ₜ−b*₁₁₇ₜ)²<2, (1)
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), said values occurring at an optical density of 1.2; and t represents a duration (sec) required to attain a maximum density when the material has been exposed to sufficient light for producing Dmax and is developed at 121° C.

It is preferable that the photothermographic material of the invention satisfies a relationship of image tone defined by the following Expression (2):
(a*₁₂₁ₜ−a*₁₁₇ₜ)²+(b*₁₂₁ₜ−b*₁₁₇ₜ)²<1.5. (2)

Further, it is preferable that the photothermographic material of the invention satisfies a relationship of image tone defined by the following Expression (3):
(a*₁₂₁ₜ−a*₁₂₁₍ₜ₋₃₎)²+(b*₁₂₁ₜ−b*₁₂₁₍ₜ₋₃₎)²<2, (3)
wherein a*₁₂₁ₜ and b*₁₂₁ₜ each represent a value of CIELAB obtained by thermal development at a developing temperature of 121° C. for t (sec), and a*₁₂₁₍ₜ₋₃₎ and b*₁₂₁₍ₜ₋₃₎ each represent a value of CIELa*b* obtained by thermal development at a developing temperature of 121° C. for t−3 (sec), said values occurring at an optical density of 1.2; and t represents a duration (sec) required to attain a maximum density when the material has been exposed to sufficient light for producing Dmax and is developed at 121° C.

Moreover, it is preferable that the photothermographic material of the invention satisfies a relationship of image tone defined by the following Expression (4):
(a*₁₂₁ₜ−a*₁₂₁₍ₜ₋₃₎)²+(b*₁₂₁ₜ−b*₁₂₁₍ₜ₋₃₎)²<1.5. (4)

Still further, it is preferable that the photothermographic material of the invention has values for a*₁₂₁ₜ, b*₁₂₁ₜ, a*₁₁₇ₜ, b*₁₁₇ₜ, a*₁₂₁₍ₜ₋₃₎ and b*₁₂₁₍ₜ₋₃₎, which are negative.

Moreover, it is preferable that the photothermographic material of the invention has a value for a*₁₂₁ₜ, which is −2 or less.

In addition, it is preferable that the non-photosensitive organic silver salt included in the photothermographic material of the invention has a silver behenate content of 35 to 85 mol %.

The invention also provides an image forming method which comprises exposing any of the above-described photothermographic materials to light and conducting thermal development to form an image.

In the image forming method according to the invention, a thermal developing duration is preferably 15 sec or less.

### DETAILED DESCRIPTION OF THE INVENTION

The present invention will now be described in more detail.

Photothermographic Material

It has been discovered by the present inventor that developing ununiformity and unstable image tones which occur during continuous processing of photothermographic material can be reduced when a photothermographic material that satisfies the following requirements is used:

1) The value for A when expressed by the following expression is 2 or less. It is preferably 1.5 or less and, more preferably, 1.0 or less.
(a*₁₂₁ₜ−a*₁₁₇ₜ)²+(b*₁₂₁ₜ−b*₁₁₇ₜ)²<A,
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), said values occurring at an optical density of 1.2; and t represents a duration (sec) required to attain a maximum density when the material has been exposed to sufficient light for producing Dmax and is developed at 121° C.

CIELa*b* is a well-known color space described in the Imaging Process and Materials book incorporated by reference above.

2) The value for B when expressed by the following expression is 2 or less. It is preferably 1.5 or less and, more preferably, 1.0 or less.
(a*₁₂₁ₜ−a*₁₂₁₍ₜ₋₃₎)²+(b*₁₂₁ₜ−b*₁₂₁₍ₜ₋₃₎)²<B,
wherein a*₁₂₁ₜ and b*₁₂₁ₜ each represent a value of CIELAB obtained by thermal development at a developing temperature of 121° C. for t (sec), and a*₁₂₁₍ₜ₋₃₎ and b*₁₂₁₍ₜ₋₃₎ each represent a value of CIELa*b* obtained by thermal development at a developing temperature of 121° C. for t−3 (sec), said values occurring at an optical density of 1.2; and t represents a duration (sec) required to attain a maximum density when the material has been exposed to sufficient light for producing Dmax and is developed at 121° C.
   3) Preferably, all of the values for a*₁₂₁ₜ, b*₁₂₁ₜ, a*₁₁₇ₜ, b*₁₁₇ₜ, a*₁₂₁₍ₜ₋₃₎, and b*₁₂₁₍ₜ₋₃₎ defined in the invention are negative. When the value for a* is positive, it is not preferred since images are in reddish black color. When the value for b* is positive, it is not preferred since the images are in yellowish black color. Accordingly, it is preferred that all of the values for a*₁₂₁ₜ, b*₁₂₁ₜ, a*₁₁₇ₜ, b*₁₁₇ₜ, a*₁₂₁₍ₜ₋₃₎, and b*₁₂₁₍ₜ₋₃₎ are negative. Further, it is preferred that a*₁₂₁ₜ is −2 or less and, more preferably, −2 or less and −4 or more.
   Organic Silver Salt
   1) Composition

The organic silver salt that may be used in the invention is relatively stable to light but, when it is heated to 80° C. or higher in the presence of an exposed photosensitive silver halide and a reducing agent, it functions as a silver ion supply source to form silver images. The organic silver salt may be any organic substance capable of supplying silver ions that can be reduced by a reducing agent. Such a non-photosensitive organic silver salt is described, for example, in Japanese Patent Application Laid-Open (JP-A) No. 10-62899, column Nos. 0048-0049, EP-A No. 0803764A1, page 18, lines 24 to page 19, line 37, EP-A No. 0962812A1, and JP-A Nos. 11-349591, 2000-7683 and 2000-72711, the disclosures of which are incorporated by reference. A silver salt of an organic acid, particularly, a silver salt of a long-chained (the number of carbon atoms is 10 to 30, and preferably 15 to 28) aliphatic carboxylic acid is preferred. Preferred examples of the fatty acid silver salt include silver lignocerate, silver behenate, silver arachidate, silver stearate, silver oleate, silver laurate, silver caproate, silver myristate, silver palmitate, silver erucate, and the mixture thereof. In the invention, among the fatty acid silver salts described above, it is preferred to use a fatty acid silver salt having a silver behenate content preferably of 35 mol % or more and 85 mol % or less, more preferably, of 45 mol % or more and 75 mol % or less and, further preferably, 45 mol % or more and 60 mol % or less. Further, it is preferred to use a fatty acid silver salt having an erucic acid content of 2 mol % or less, more preferably, 1 mol % or less and, further preferably, 0.1 mol % or less.

2) Shape

There is no particular restriction on the shape of the organic silver salt usable in the invention and it may be needle-like, rod-like, plate-like or flaky shape.

The particle sizes of the organic silver salt preferably have a monodispersed size distribution. In the monodispersed distribution, the standard deviation of the length of the minor axis or major axis of the particles divided by a length value of the minor axis or major axis, respectively, is preferably not more than 100%, more preferably not more than 80%, and still more preferably not more than 50%. The shape of particles of the salt may be determined from an observed image of a dispersion thereof through a transmission electron microscope. The particle size distribution of the salt may alternatively be determined by employing the standard deviation of the volume weighted mean diameter of the particles, and is monodispersed if a percentage obtained by dividing the standard deviation of the volume weighted mean diameter by the volume weighted mean diameter (coefficient of variation) is not more than 100%, more preferably not more than 80%, and still more preferably not more than 50%. The particle size (volume weighted mean diameter) may be determined, for example, by applying laser light to the organic silver salt dispersed in a liquid and determining an autocorrelation function of the variation of fluctuation of scattered light with time.

3) Preparation

Known methods may be applied to the preparation of the organic acid silver salt and dispersion method thereof in the invention. For example, reference may be made to JP-A No. 10-62899, EP-A Nos. 0803763A1 and 0962812A1, JP-A Nos. 11-349591, 2000-7683, 2000-72711, 2001-163889, 2001-163890, 2001-163827, 2001-33907, 2001-188313, 2001-836652, 2002-6442, 2002-49117, 2002-31870 and 2002-107868, the disclosures of which are incorporated herein by reference.

A dispersion of the organic silver salt is preferably substantially free from any photosensitive silver salt, since fogging will be increased and its sensitivity will be greatly lowered. According to the present invention, an aqueous dispersion contains not more than 0.1 mol % of a photosensitive silver salt per 1 mol % of the organic silver salt, and photosensitive silver salt should not be added thereto.

According to the present invention, the photosensitive material may be prepared by mixing an aqueous dispersion of an organic silver salt with an aqueous dispersion of a photosensitive silver salt in a ratio depending on the purpose for which it will be used, preferably employing 1 to 30 mol %, more preferably 2 to 20 mol %, and still more preferably 3 to 15 mol % of the photosensitive silver salt relative to the organic silver salt. It is preferable, for obtaining a material having controlled photographic properties, to mix two or more kinds of aqueous dispersions of organic silver salts with two or more kinds of aqueous dispersions of photosensitive silver salts.

4) Addition Amount

The organic silver salt in the invention may be used by a desired amount, and the amount in terms of the coating amount of silver per m² is, preferably, 0.1 to 5.0 g/m², more preferably, 0.3 to 3.0 g/m² and, further preferably, 0.5 to 2.0 g/m². Particularly, for improving the image storability, it is preferred that the entire coating amount of silver is 1.8 g/m² or less and, more preferably, 1.6 g/m². When a preferred reducing agent of the invention is used, a sufficient image density may be obtained even using such a small amount of silver.

Reducing Agent

The photothermographic material of the present invention preferably contains a reducing agent for silver ions. The reducing agent (preferably an organic substance) may be any substance capable of reducing a silver ion to metallic silver. Such reducing agents are described in paragraphs [0043] to [0045] of Japanese Patent Application Laid-Open No. 11-65021, and page 7, line 34 to page 18, line 12 of European Patent Laid-Open No. 0803764A1, the disclosure of which is incorporated by reference.

In the invention, a so-called hindered phenol-type reducing agent or a bisphenol-type reducing agent which has a substituent at an ortho-position of a phenolic hydroxyl group, is preferable as the reducing agent, and a compound represented by the following formula (R) is more preferred.

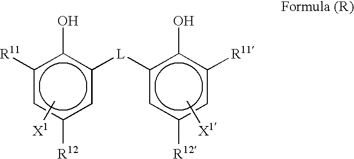

In formula (R), R¹¹ and R^{11′} each independently represent an alkyl group having 1 to 20 carbon atoms. R¹² and R^{2′} each independently represent a hydrogen atom or a substituent capable of substitution on the benzene ring. L represents a group —S— or a group —CHR¹³—. R¹³ represents a hydrogen atom or an alkyl group having 1 to 20 carbon atoms. X¹ and X^{1′} each independently represent a hydrogen atom or a group capable of substitution on the benzene ring.

Description of formula (R) is given in more detail below.

1) R¹¹ and R^{11′}

R¹¹ and R^{11′} each independently represent substituted or unsubstituted alkyl group having 1 to 20 carbon atoms. The substituent for the alkyl group has no particular restriction and may include, preferably, an aryl group, hydroxy group, alkoxy group, aryloxy group, alkylthio group, arylthio group, acylamino group, sulfoneamide group, sulfonyl group, phosphoryl group, acyl group, carbamoyl group, ester group, ureido group, urethane group, and a halogen atom.

2) R¹² and R^{12′} and X¹ and X^{1′}

R¹² and R^{12′} each independently represent a hydrogen atom or a substituent capable of substitution on the benzene ring. X¹ and X^{1′} each independently represent a hydrogen atom or a group capable of substitution on the benzene ring. Each of the groups capable of substitution on the benzene ring may include, preferably, an alkyl group, aryl group, halogen atom, alkoxy group, and acylamino group.

3) L

L represents a group —S— or a group —CHR¹³—. R¹³ represents a hydrogen atom or an alkyl group having 1 to 20 carbon atoms in which the alkyl group may have a substituent. Specific examples of the unsubstituted alkyl group for R¹³ include a methyl group, ethyl group, propyl group, butyl group, heptyl group, undecyl group, isopropyl group, 1-ethylpentyl group, and 2,4,4-trimethylpentyl group. Examples of the substituent for the alkyl group include, like substituent R¹¹, a halogen atom, an alkoxy group, alkylthio group, aryloxy group, arylthio group, acylamino group, sulfoneamide group, sulfonyl group, phosphoryl group, oxycarbonyl group, carbamoyl group, and sulfamoyl group.

4) Preferable Substituent

R¹¹ and R^{11′} each represent, preferably, a secondary or tertiary alkyl group having 3 to 15 carbon atoms. Specific examples thereof include an isopropyl group, isobutyl group, t-butyl group, t-amyl group, t-octyl group, cyclohexyl group, cyclopentyl group, 1-methylcyclohexyl group, and 1-methylcyclopropyl group. R¹¹ and R^{11′} each represent, more preferably, a tertiary alkyl group having 4 to 12 carbon atoms and, among them, t-butyl group, t-amyl group, with 1-methylcyclohexyl group being more preferred, and t-butyl group being most preferred.

R¹² and R^{12′} each represent, preferably, alkyl groups having 1 to 20 carbon atoms. Specific examples thereof include a methyl group, ethyl group, propyl group, butyl group, isopropyl group, t-butyl group, t-amyl group, cyclohexyl group, 1-methylcyclohexyl group, benzyl group, methoxymethyl group and methoxyethyl group. More preferred are a methyl group, ethyl group, propyl group, isopropyl group, and t-butyl group.

X¹ and X^{1′} each represent, preferably, a hydrogen atom, halogen atom, or an alkyl group, and more preferably, a hydrogen atom.

L represents preferably a group —CHR¹³—.

R¹³ represents, preferably, a hydrogen atom or an alkyl group having 1 to 15 carbon atoms. The alkyl group is preferably a methyl group, ethyl group, propyl group, isopropyl group, and 2,4,4-trimethylpentyl group. Particularly preferred R¹³ is a hydrogen atom, a methyl group, ethyl group, propyl group or isopropyl group.

In a case where R¹³ is a hydrogen atom, R¹² and R^{12′} each represent, preferably, an alkyl group having 2 to 5 carbon atoms, with an ethyl group and a propyl group being more preferred and an ethyl group being most preferred.

In a case where R¹³ is a primary or secondary alkyl group having 1 to 8 carbon atom, R¹² and R^{12′} each represent, preferably, a methyl group. As the primary or secondary alkyl group having 1 to 8 carbon atoms for R¹³, a methyl group, ethyl group, propyl group or isopropyl group is more preferred, and a methyl group, ethyl group or propyl group is further preferred.

In a case where each of R¹¹, R^{11′}, R¹² and R^{12′} is a methyl group, R¹³ is preferably a secondary alkyl group. In this case, the secondary alkyl group for R¹³ is, preferably, an isopropyl group, isobutyl group, and 1-ethylpentyl group, with isopropyl group being more preferred.

The reducing agents described above may exhibit different heat developing properties and silver tones after development, depending on various combinations of R¹¹, R¹¹′, R¹², R^{12′} and R¹³. Depending on the purposes, the reducing agents may be used in combination of two or more kinds thereof.

Specific examples of the reducing agent including the compounds represented by formula (R) according to the invention are shown below but the invention is not limited thereto.

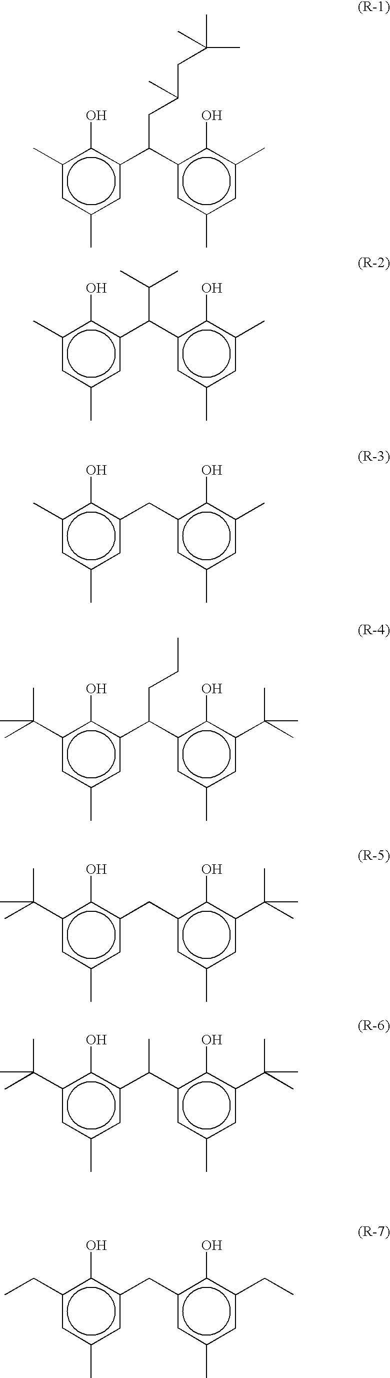

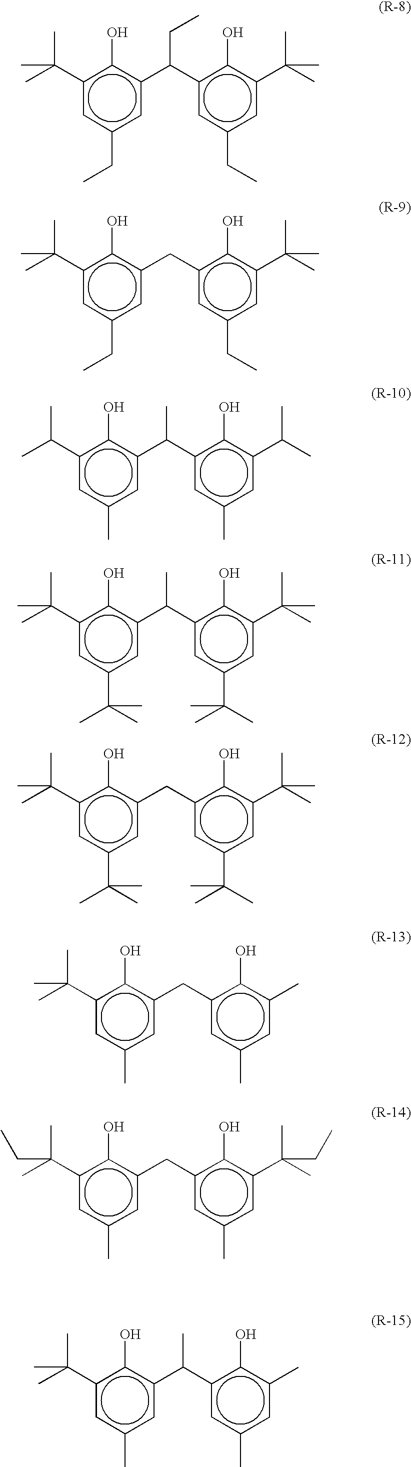

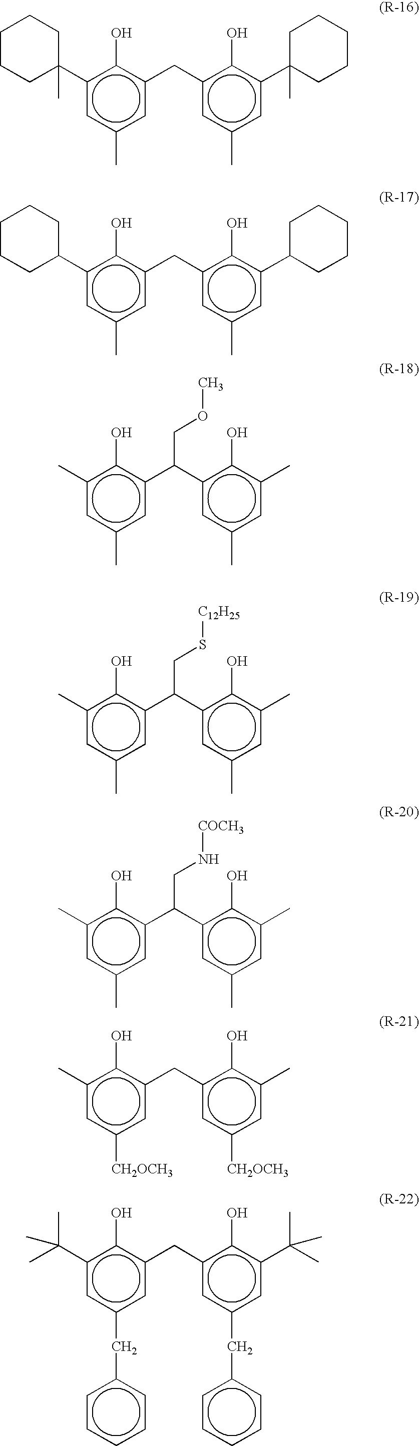

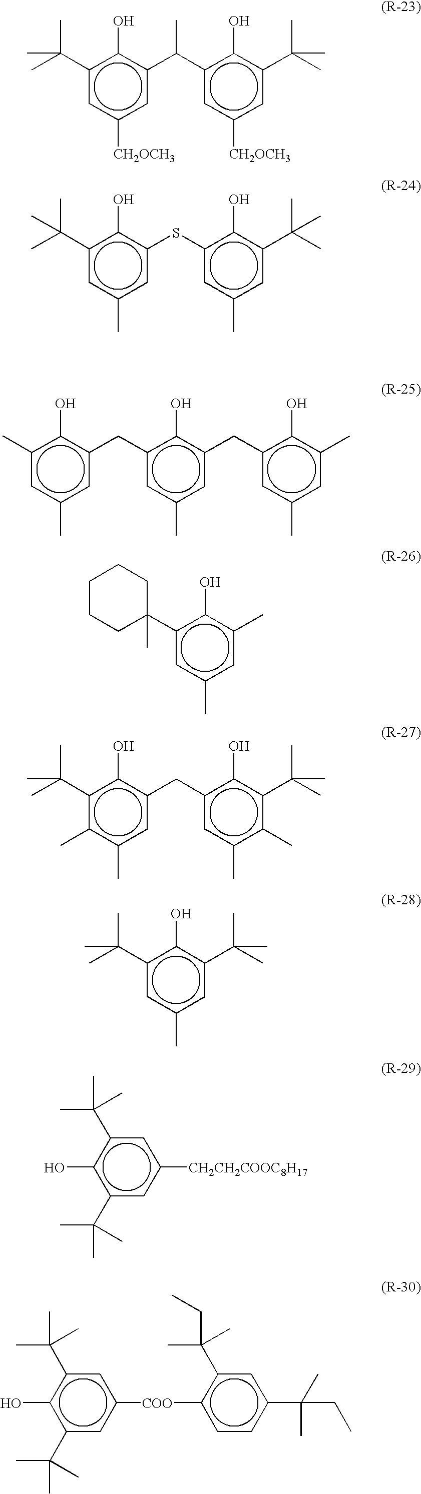

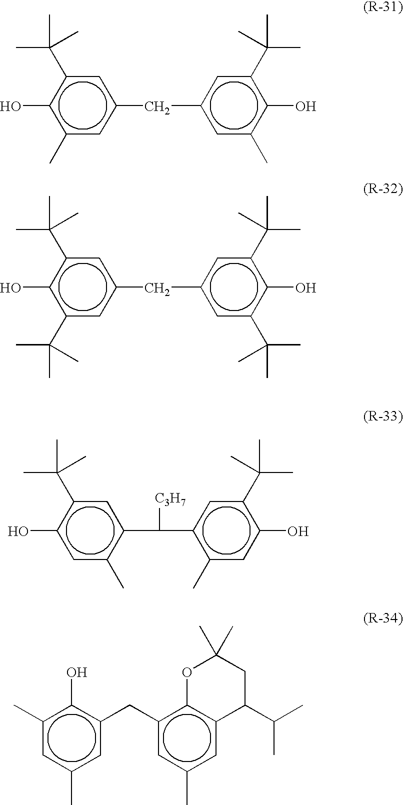

Preferred examples of the reducing agent of the invention other than those described above are compounds described in JP-A Nos. 2001-188314, 2001-209145, 2001-350235, and 2002-156727, the disclosures of which are incorpoarated by reference.

In the invention, the amount of the reducing agent is, preferably, from 0.1 to 3.0 g/m², more preferably, 0.2 to 1.5 g/m², and, further preferably, 3.0 to 1.0 g/m². It is preferably present in an amount of 5 to 50 mol %, more preferably 8 to 30 mol %, and further preferably 10 to 20 mol % per mol of silver on the surface having the image-forming layer. The reducing agent is, preferably, present in the image-forming layer.

The reducing agent may be contained through any means, such as in the form of a solution, emulsified dispersion and fine solid particle dispersion, into a coating solution and contained in the photosensitive material.

Well-known emulsified dispersions may be formed by a method of dissolving using an oil such as dibutyl phthalate, tricresyl phosphate, glyceryl triacetate or diethyl phthalate, or an auxiliary solvent such as ethyl acetate or cyclohexanone, and mechanically preparing an emulsified dispersion.

Further, the fine solid particle dispersing method may be used. This method involves dispersing a powder of the reducing agent in an appropriate solvent such as water using a ball mill, colloid mill, vibration mill, sand mill, jet mill, roller mill or ultrasonic waves to prepare a solid dispersion. In this case, a protective colloid (e.g., polyvinyl alcohol), a surfactant (anionic surfactant, e.g., sodium triisopropyl naphthalene sulfonate (a mixture having three isopropyl groups on different substitution positions)) may also be used. As the dispersing vehicle used in the mill, beads such as zirconia are typically used, and Zr or the like eluting from the beads may sometimes contaminate the dispersion. Depending on the dispersing conditions, it is usually within a range of 1 ppm to 1,000 ppm. When the content of Zr in the photosensitive material is 0.5 mg or less per g of silver, it causes no practical problem.

A corrosion inhibitor (e.g., sodium benzoisothiazolinone) is preferably included in the aqueous dispersion.

The solid particle dispersing method is particularly preferably employed for the reducing agent, and fine particles are added preferably with an average particle size of 0.01 μm to 10 μm, preferably 0.05 μm to 5 μm, and more preferably 0.1 to 2 μm. In the invention, other solid dispersions may also preferably used when having a particle size of the above range.

Development Accelerator

In the photothermographic material according to the invention, a sulfonamide phenol-type compound represented by the general formula (A) described in JP-A Nos. 2000-267222, 2000-330234 and the like, a hindered phenol-type compound represented by the general formula (II) described in JP-A No. 2001-92075, a hydrazine-type compound represented by the general formula (I) described in JP-A Nos. 10-62895, 11-15116 and the like, or represented by the general formula (1) described in Japanese Patent Application No. 2001-074278, and a phenol-type or naphthol-type compound represented by the general formula (2) described in Japanese Patent Application No. 2001-264929 are preferably used as the development accelerator. Such development accelerators are used, relative to the reducing agent, in a range of from 0.1 mol % to 20 mol %, preferably from 0.5 mol % to 10 mol %, and more preferably from 1 mol % to 5 mol %. A method for incorporating it to the photothermographic material is the same as that used for the reducing agent. Particularly, an addition thereof as a solid dispersion or an emulsified dispersion is preferable. When the developing accelerator is added as the emulsified dispersion, it is preferably added either as the emulsified dispersion prepared using a high boiling-point solvent which is solid at normal temperature and a low boiling-point auxiliary solvent, or as a so-called oil-less emulsified dispersion prepared without using a high boiling-point solvent.

In the invention, it is more preferred to use, among the development accelerators described above, hydrazine-type compounds represented by formula (D) described in the specification of JP-A No. 2002-156727, and phenol-type or naphthol-type compounds represented by the general formula (2) described in the specification of JP-A No. 2001-264929.

Particularly preferred development accelerator of the invention is compounds represented by the following formulae (A-1) or (A-2).
Q¹-NHNH-Q² Formula (A-1)
wherein Q¹ represents an aromatic group or a heterocyclic group whose carbon atom binds to —NHNH-Q², and Q² represents a carbamoyl group, acyl group, alkoxycarbonyl group, aryloxycarbonyl group, sulfonyl group or sulfamoyl group.

In formula (A-1), the aromatic group or heterocyclic group represented by Q¹ is, preferably, a 5 to 7 membered unsaturated ring. Preferred examples of the ring include benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isooxazole ring, and thiophene rings. Also, these rings may preferably be condensed to each other to form a condensed ring.

The rings described above may have a substituent, and in a case where they have two or more substituents, the substituents may be identical to or different from each other. Examples of the substituents may include halogen atom, alkyl group, aryl group, carboamide group, alkylsulfoneamide group, arylsulfonamide group, alkoxy group, aryloxy group, alkylthio group, arylthio group, carbamoyl group, sulfamoyl group, cyano group, alkylsulfonyl group, arylsulfonyl group, alkoxycarbonyl group, aryloxycarbonyl group and acyl group. In a case where the substituents are groups capable of being substituted, they may have further substituents, and preferable examples of the substituents include a halogen atom, an alkyl group, aryl group, carbonamide group, alkylsulfoneamide group, arylsulfoneamide group, alkoxy group, aryloxy group, alkylthio group, arylthio group, acyl group, alkoxycarbonyl group, aryloxycarbonyl group, carbamoyl group, cyano group, sulfamoyl group, alkylsulfonyl group, arylsulfonyl group and acyloxy group.

The carbamoyl group represented by Q² is a carbamoyl group preferably having 1 to 50 carbon atoms and, more preferably, of 6 to 40 carbon atoms, for example, unsubstituted carbamoyl, methyl carbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxycarbonylphenyl)carbamoyl, N-nathphthylcarbaoyl, N-3-pyridylcarbamoyl and N-benzylcarbamoyl.

The acyl group represented by Q² is an acyl group, preferably, having 1 to 50 carbon atoms and, more preferably, 6 to 40 carbon atoms and may include, for example, formyl, acetyl, 2-methylpropanoyl, cyclohexylcarbonyl, octanoyl, 2-hexyldemayoyl, dodemayoyl, chloroacetyl, trifluoroacetyl, benzoyl, 4-dodecyloxybenzoyl, and 2-hydroxymethylbenzoyl. Alkoxycarbonyl group represented by Q² is an alkoxycarbonyl group, preferably, having 2 to 50 carbon atom and, more preferably, having 6 to 40 carbon atoms and may include, for example, methoxycarbonyl, ethoxycarbonyl, isobutyloxycarbonyl, cyclohexyloxycarbonyl, dodecyloxycarbonyl and benzyloxycarbonyl.

The aryloxy carbonyl group represented by Q² is an aryloxycarbonyl group, preferably, having 7 to 50 carbon atoms and, more preferably, having 7 to 40 carbon atoms and may include, for example, phenoxycarbonyl, 4-octyloxyphenoxycarbonyl, 2-hydroxymethylphenoxycarbonyl, and 4-dodecyloxyphenoxycarbonyl. The sulfonyl group represented by Q² is a sulfonyl group, preferably, having 1 to 50 carbon atoms and, more preferably, having 6 to 40 carbon atoms and may include, for example, methylsulfonyl, butylsulfonyl, octylsulfonyl, 2-hexadecylsulfonyl, 3-dodecyloxypropylsulfonyl, 2-octyloxy-5-tert-octylphenyl sulfonyl, and 4-dodecyloxyphenyl sulfonyl.

The sulfamoyl group represented by Q² is a sulfamoyl group, preferably, having 0 to 50 carbon atoms, more preferably, 6 to 40 carbon atoms and may include, for example, unsubstituted sulfamoyl, N-ethylsulfamoyl, N-(2-ethylhexyl)sulfamoyul, N-decylsulfamoyl, N-hexadecylsulfamoyl, N-{3-(2-ethylhexyloxy)propyl}sulfamoyl, N-(2-chloro-5-dodecyloxycarbonylphenyl) sulfamoyl, and N-(2-tetradecyloxyphenyl)sulfamoyl. The group represented by Q² may further have a substituent group mentioned as the example of the substituent for 5 to 7-membered unsaturated ring represented by Q¹ at the position capable of substitution. In a case where the group has two or more substituents, such substituents may be identical to or different from each other.

Next, preferred compounds represented by formula (A-1) are described. Q¹ is preferably a 5- or 6-membered unsaturated ring, more preferably a benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thioazole ring, oxazole ring, isothiazole ring, and isooxazole ring. Also preferably, these rings may be condensed with a benzene ring or unsaturated heterocyclic ring to form a condensed ring. Further, Q² is preferably a carbamoyl group and, particularly, a carbamoyl group having a hydrogen atom bonded to the nitrogen atom.

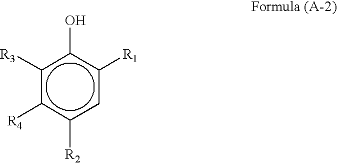

In Formula (A-2), R₁ represents an alkyl group, acyl group, acylamino group, sulfoneamide group, alkoxycarbonyl group, and carbamoyl group. R₂ represents a hydrogen atom, halogen atom, an alkyl group, alkoxy group, aryloxy group, alkylthio group, arylthio group, acyloxy group and carbonate ester group. R₃ and R₄ each represent a group capable of substitution on the benzene ring which is mentioned as the example of the substituent for formula (A-1). R₃ and R₄ may be connected to each other to form a condensed ring.

R₁ is, preferably, an alkyl group having 1 to 20 carbon atoms (e.g., methyl group, ethyl group, isopropyl group, butyl group, tert-octyl group, or cyclohexyl group), acylamino group (e.g., acetylamino group, benzoylamino group, methylureido group, or 4-cyanophenylureido group), carbamoyl group (e.g., n-butylcarbamoyl group, N,N-diethylcarbamoyl group, phenylcarbamoyl group, 2-chlorophenylcarbamoyl group, or 2,4-dichlorophenylcarbamoyl group), with an acylamino group (including an ureido group or an urethane group) being more preferred.

R₂ is, preferably, a halogen atom (more preferably, chlorine atom, bromine atom), alkoxy group (e.g., methoxy group, butoxy group, n-hexyloxy group, n-decyloxy group, cyclohexyloxy group or benzyloxy group), and aryloxy group (phenoxy group or naphthoxy group).

R₃ is, preferably a hydrogen atom, halogen atom or an alkyl group having 1 to 20 carbon atoms, with the halogen atom being most preferred. R₄ is preferably a hydrogen atom, alkyl group or an acylamino group, with the alkyl group or the acylamino group being more preferred. Examples of the preferred substituents thereof are identical with those for R₁. In a case where R₄ is an acylamino group, R₄ may preferably be connected to R₃ to form a carbostyryl ring.

In a case where R₃ and R₄ in formula (A-2) are connected to each other to form a condensed ring, a naphthalene ring is particularly preferred as the condensed ring. The same substituent as the example of the substituent referred to for formula (A-1) may be connected to the naphthalene ring. In a case where formula (A-2) is a naphtholic compound, R₁ is, preferably, a carbamoyl group. Among them, a benzoyl group is particularly preferred. R₂ is, preferably, an alkoxy group or aryloxy group and, particularly, preferably an alkoxy group.

Preferable examples of the development accelerator for use in the invention are to be described below, however, the invention is not restricted thereto. 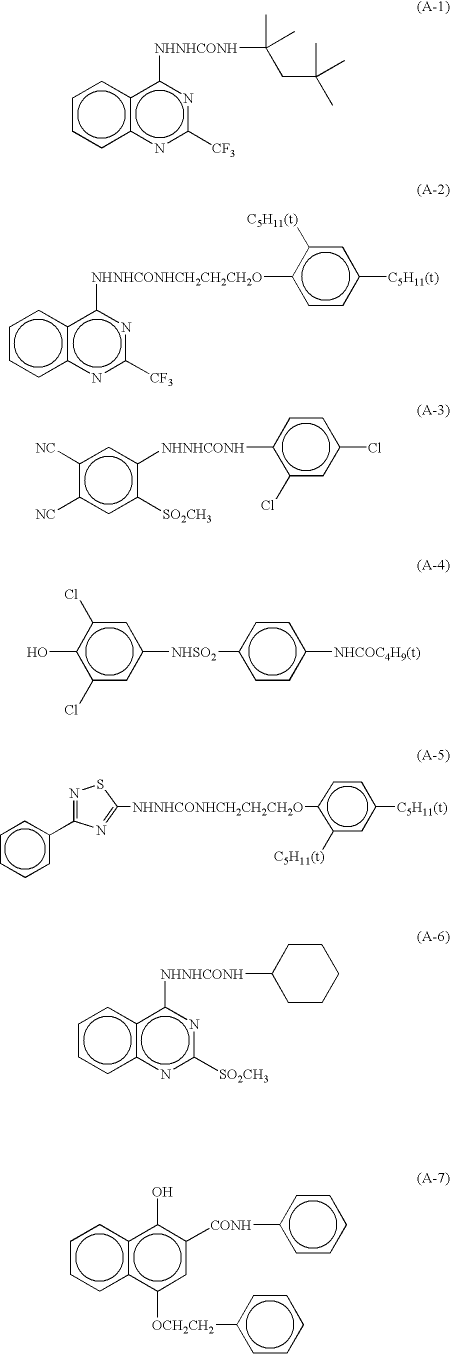 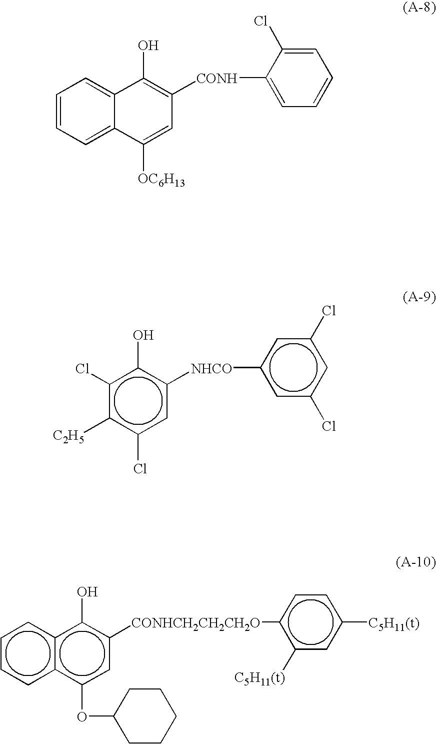
Hydrogen Bond-Forming Compound

In a case where the reducing agent in the invention has an aromatic hydroxyl group (—OH) or amino group (—NHR, in which R is a hydrogen atom or alkyl group), particularly in a case of bisphenols, it is preferred to use a non-reducing compound having a group capable of forming a hydrogen bond with the group described above in combination.

The group capable of forming the hydrogen bond with a hydroxyl group or amino group may include, for example, a phosphoryl group, sulfoxide group, sulfonyl group, carbonyl group, amide group, ester group, urethane group, ureido group, tertiary amino group, and nitrogen-containing aromatic group. Among them, preferred are those compounds having a phosphoryl group, sulfoxide group, amide group (not having >N—H group but blocked like >N—Ra, in which Ra is a substituent other than H), urethane group (not having >N—H group but blocked like >N—Ra, in which Ra is a substituent other than H), ureido group (not having >N—H group but blocked like >N—Ra, in which Ra is a substituent other than H).

In the invention, a particularly preferred hydrogen bond-forming compound is the compound represented by the following formula (D).

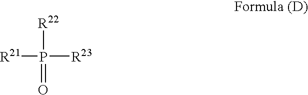

In formula (D), R²¹ to R²³ each independently represent an alkyl group, aryl group, alkoxy group, aryloxy group, amino group or heterocyclic group, which may be unsubstituted or substituted.

In a case where R²¹ to R²³ have a substituent, the substituent may include, for example, a halogen atom, an alkyl group, aryl group, alkoxy group, amino group, acyl group, acylamino group, alkylthio group, arylthio group, sulfoneamide group, acyloxy group, oxycarbonyl group, carbamoyl group, sulfamoyl group, sulfonyl group, and phosphoryl group. Preferred substituent may include an alkyl group or aryl group, for example, a methyl group, ethyl group, isopropyl group, t-butyl group, t-octyl group, phenyl group, 4-alkoxyphenyl group, and 4-acyloxyphenyl group.

The alkyl group of R²¹ to R²³ may specifically include, for example, a methyl group, ethyl group, butyl group, octyl group, dodecyl group, isopropyl group, t-butyl group, t-amyl group, t-octyl group, cyclohexyl group, 1-methylcyclohexyl group, benzyl group, phenetyl group, and 2-phenoxypropyl group.

The aryl group may include, for example, a phenyl group, cresyl group, xylyl group, naphthyl group, 4-t-butylphenyl group, 4-t-octylphenyl group, 4-anisidyl group, and 3,5-dichlorophenyl group.

The alkoxy group may include, for example, a methoxy group, ethoxy group, butoxy group, octyloxy group, 2-ethylhexyloxy group, 3,5,5-trimethylhexyloxy group, dodecyloxy group, cyclohexyloxy group, 4-methylcyclohexyloxy group, and benzyloxy group.

The aryloxy group may include, for example, a phenoxy group, cresyloxy group, isopropylphenoxy group, 4-t-butylphenoxy group, naphthoxy group, and biphenyloxy group.

The amino group may include, for example, a dimethylamino group, diethylamino group, dibutylamino group, dioctylamino group, N-methyl-N-hexylamino group, dicyclohexylamino group, diphenylamino group, and N-methyl-N-phenylamino group.

As R²¹ to R²³, an alkyl group, aryl group, alkoxy group, and aryloxy group are preferred. From the standpoint of effectiveness of the invention, it is preferred that at least one of R²¹ to R²³ is an alkyl or aryl group, and it is more preferred that two or more of them are alkyl or aryl group. Further, in view of the availability at a reduced cost, it is preferred that R²¹ to R²³ are of an identical group.

Specific examples of the hydrogen bond-forming compounds including the compound of formula (D) in the invention are shown below, but the invention is not restricted thereto.

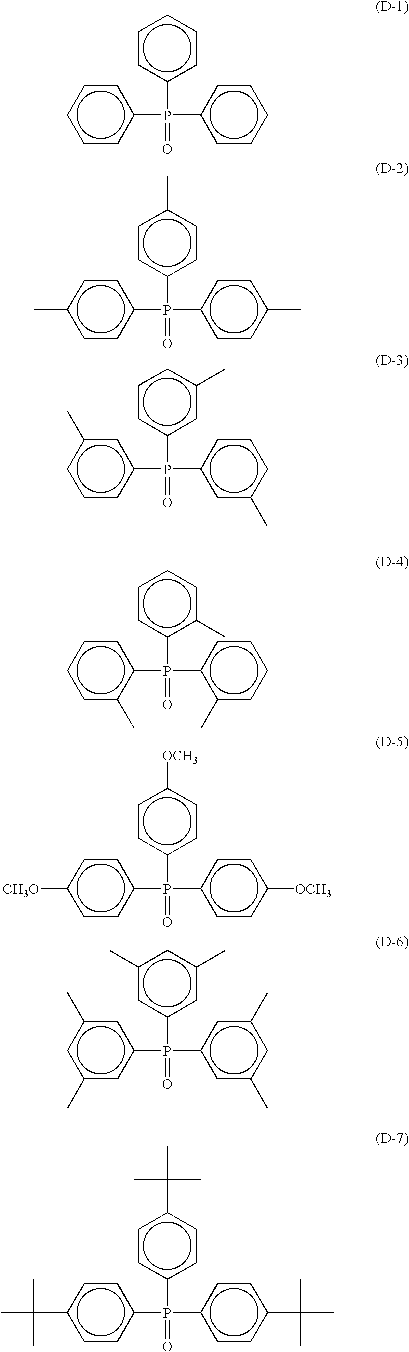

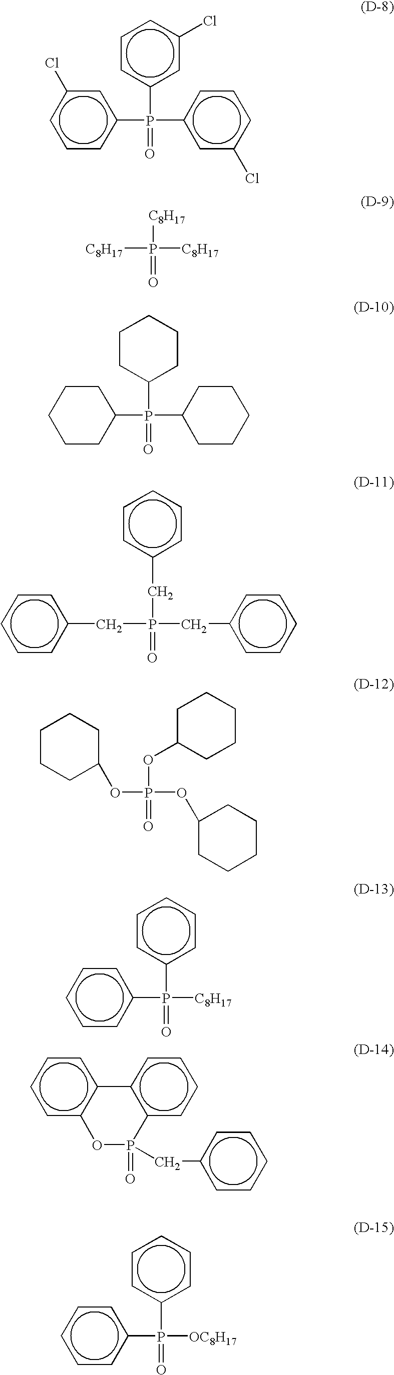

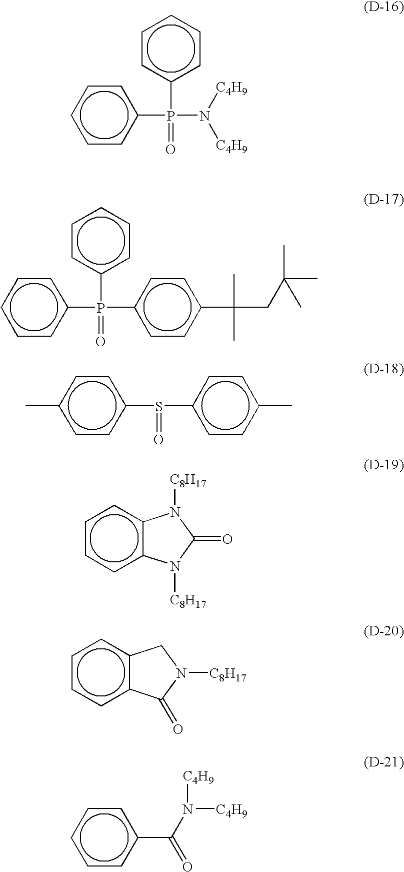

Specific examples of the hydrogen bond-forming compound include, in addition to those described above, those described in EP-A No. 1096310, JP-A No. 2002-15672, and Japanese Patent Application No. 2001-124796, the disclosures of which are incorporated by reference.

The compound represented by formula (D) of the invention, like the reducing agent, may be incorporated in a coating solution in the form of a solution, emulsified dispersion and fine solid particles dispersion and may be contained in the photosensitive material. The compound of the invention forms a hydrogen-bonding complex with a compound having the phenolic hydroxyl group and the amino group in the state of solution, and may be isolated in the form of crystals as a complex depending on the combination with the reducing agent and the compound represented by formula (D).

Use of the thus isolated crystal powder for the fine solid particles dispersion is particularly preferred for obtaining stable performance. Further, a method of mixing the reducing agent and of formula (D) compound of the invention, in the form of a powder, and forming a complex during dispersing operation using a sand grinder mill with an aid of an appropriate dispersant may also preferably be used.

The compound represented by formula (D) of the invention is used within a range, preferably, from 1 to 200 mol %, more preferably, 10 to 150 mol % and, further preferably, 20 to 100 mol % based on the reducing agent.

Silver Halide

1) Halogen Composition

The halogen composition of the photosensitive silver halide grains for use in the present invention is not specifically limited, and there may be used silver chloride, silver chlorobromide, silver bromide, silver iodobromide, and silver iodochlorobromide. Regarding the halide distribution in individual grains, the halide may be uniformly distributed throughout the grain, or may stepwise distributed, or may continuously distributed. Silver halide grains having a core/shell structure are preferably used. Preferably, the core/shell structure of the grains has 2 to 5 layers, more preferably 2 to 4 layers. Also a technique to localize silver bromide on the surface of silver chloride or silver chlorobromide grains is preferably employed.

2) Method of Forming Grains

Methods of forming photosensitive silver halides are well known in the art and may be employed in the present invention, for example, as described in Research Disclosure No.17029 (June 1978), and U.S. Pat. No. 3,700,458, the disclosure of which is incorporated herein by reference. More specifically, a silver source-supplying compound and a halogen source-supplying compound are added to a solution of gelatin or any other polymer to prepare a photosensitive silver halide, followed by admixing with an organic silver salt. Further, the method described in JP-A No.11-119374, paragraphs [0217] to [0244]; and the methods described in JP-A Nos.11-98708 and 2000-347335 are also preferable.

3) Grain Size

The photosensitive silver halide grains preferably have a smaller size in order to prevent the formed images from becoming cloudy. Specifically, the size is preferably at most 0.20 μm, more preferably falling between 0.01 μm and 0.15 μm, and even more preferably between 0.02 μm and 0.12 μm. The grain size as used herein refers to the diameter of the circular image having the same area as the projected area of each silver halide grain (for tabular grains, the main plane of each grain is projected to determine the projected area of the grain).

4) Grain Shape

Silver halide grains may have various shapes including, for example, cubic grains, octahedral grains, tabular grains, spherical grains, rod-like grains, and potato-like grains. Cubic silver halide grains are especially preferred for use in the present invention. Also preferred are roundish silver halide grains having rounded corners.

The surface index (Miller's index) of the outer surface of the photosensitive silver halide grains for use in the present invention is not specifically limited, but it is preferred that the proportion of {100} plane, which ensures higher spectral sensitization when it has adsorbed a color-sensitizing dye, in the outer surface is large. Preferably, the proportion of {100} plane is at least 50%, more preferably at least 65%, and even more preferably at least 80%. The Miller's index expressed by the proportion of {100} plane can be obtained according to the method described in J. Imaging Sci., written by T. Tani, 29, 165 (1985), based on the adsorption dependency of {111} plane and {100} plane for sensitizing dyes.

5) Heavy Metal

The photosensitive silver halide grains for use in the present invention may contain a metal or metal complex of Groups VIII to X of the Periodic Table (including Groups I to XVIII). As the metal or the central metal of metal complex of Groups VIII to X, preferably used is rhodium, ruthenium or iridium. In the present invention, one metal complex may be used alone, or two or more metal complexes of the same species or different species of metals may be used in combination. The metal or metal complex content of the grains preferably falls between 1×10⁻⁹ mols and 1×10⁻³ mols per mol of silver. Such heavy metals and metal complexes, and methods of adding them to silver halide grains are described in, for example, JP-A No.7-225449, JP-A No.11-65021, paragraphs [0018] to [0024], and JP-A No. 11-119374, paragraphs [0227] to [0240].

In the invention, silver halide grains having hexacyano-metal complex on an outermost surface thereof are preferably used. The hexacyano-metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano-Fe complexes are preferably used in the present invention.

As hexacyano-metal complexes exist in the form of ions in their aqueous solutions, their counter cations are of no importance. However, it is preferable to use as the counter cation any of alkali metal ions such as sodium ion, potassium ion, rubidium ion, cesium ion and lithium ion; ammonium ion, and alkylammonium ion (e.g., tetramethylammonium ion, tetraethylammonium ion, tetrapropylammonium ion and tetra(n-butyl)ammonium ion) due to good water miscibility and easy handling of silver halide emulsion sedimentation.

The hexacyano-metal complex may be added in the form of a solution thereof in water or in a mixed solvent of water and an organic solvent miscible with water (e.g., alcohols, ethers, glycols, ketones, esters, amides), or in the form of a mixture with gelatin.

The amount of the hexacyano-metal complex to be added preferably falls between 1×10⁻⁵ mols and 1×10⁻² mols, per mol of silver, and more preferably between 1×10⁻⁴ mols and 1×10⁻³ mols.

In order to dispose the hexacyano-metal complex on the outermost surface of silver halide grains, addition of the complex is conducted in the charging step, i.e., after an aqueous silver nitrate solution to form silver halide grains has been added to a reaction system but before the grains having formed are subjected to chemical sensitization such as chalcogen sensitization with sulfur, selenium or tellurium or noble metal sensitization with gold or the like, or alternatively the complex is directly added to the grains in the step of water washing, dispersing or prior to conducting chemical sensitization. In order to prevent growth of the silver halide grains excessively, it is desirable to add the hexacyano-metal complex to the grains immediately after they are formed, and preferably before the charging step is completed.

Addition of the hexacyano-metal complex to silver halide grains may be started after 96% by mass of the total of silver nitrate for forming the grains has been added to a reaction system, but is preferably started after 98% by mass of silver nitride has been added thereto, more preferably after 99% by mass thereof has been added thereto.

The hexacyano-metal complex, when added to silver halide grains after an aqueous solution of silver nitrate has been added to the reaction system but just before the grains are completely formed, may be adsorbed by the grains formed to exist on the outermost surface thereof. Most of the complex thus added can form hardly-soluble salts with the silver ions present on the surface of the grains. Since the silver salt of hexacyano-iron(II) is more hardly soluble than AgI, fine grains are prevented from re-dissolving. Consequently, fine silver halide grains having a small grain size may be produced.

The metal atoms (e.g., [Fe(CN)₆]⁴⁻) that may be included to the silver halide grains for use in the present invention, as well as the methods of desalting or chemical sensitization of the silver halide emulsions are described, for example, in JP-A No.11-84574, paragraphs [0046] to [0050], JP-A No.11-65021, paragraphs [0025] to [0031], and JP-A No. 1′-119374, paragraphs [0242] to [0250].

6) Gelatin

Various kinds of gelatins may be used for preparing the photosensitive silver halide emulsions for use in the present invention. In order to sufficiently disperse the photosensitive silver halide emulsion in a coating solution containing an organic silver salt, preferably used is a low-molecular gelatin having a molecular weight of from 10,000 to 1000,000. The phthalated gelatin is preferably used. The low-molecular gelatin may be used when forming the silver halide grains or when dispersing the grains after the grains have been desalted. Preferably, it is used when dispersing the grains after they have been desalted.

7) Sensitizing Dye

As the sensitizing dyes applicable in the invention, those dyes capable of spectrally sensitizing silver halide grains in a desired wavelength region are advantageously selected. The sensitizing dye is adsorbed to silver halide grains having a spectral sensitivity suitable to the spectral characteristics of an exposure light source. Details of sensitizing dyes and methods for adding them to the photothermographic material of the present invention, reference are made to paragraphs [0103] to [0109] in JP-A No.11-65021; compounds of formula (II) in JP-A No.10-186572; dyes of formula (I) and paragraph [0106] in JP-A No.11-119374; dyes described in U.S. Pat. Nos. 5,510,236 and 3,871,887 (Example 5); dyes described in JP-A Nos.2-96131 and 59-48753; from page 19, line 38 to page 20, line 35 in EP No.0803764A1; JP-A Nos.2001-272747, 2002-290238 and 2002-23306. These sensitizing dyes may be used herein either singly or in combination of two or more. Regarding the time at which the sensitizing dye is added to the silver halide emulsion in the present invention, it is desirable that the sensitizing dye is added thereto after the desalting step but before the coating step, more preferably after the desalting step but before the chemical ripening step.

The amount of the sensitizing dye to be included in the photothermographic material of the present invention varies as desired, depending on the sensitivity and the fogging properties of the material. In general, it preferably falls between 10⁻⁶ and 1 mol, more preferably between 10⁻⁴ and 10⁻¹ mols, per mol of the silver halide in the image-forming layer of the material.

In order to improve spectral sensitization, a supersensitizer may be used in the present invention. For the supersensitizer, for example, usable are the compounds described in EP No.587,338, U.S. Pat. Nos. 3,877,943, 4,873,184, and JP-A Nos.5-341432, 11-109547 and 10-111543, the disclosures of which are incorporated by reference.

8) Chemical Sensitization

Preferably, the photosensitive silver halide grains for use in the present invention are chemically sensitized with, for example, sulfur, selenium or tellurium. For such sulfur, selenium or tellurium sensitization, any known compounds are usable. For example, preferred are the compounds described in JP-A No.7-128768. Tellurium sensititization is preferably conducted in the present invention, using the compounds described in JP-A No.11-65021, paragraph [0030], and the compounds of formulae (II), (III) and (IV) given in JP-A No.5-313284.

It is preferable that the photosensitive silver halide according to the invention is chemically sensitized by a gold sensitization method either alone or in combination with the above-described chalcogen sensitization. As for a gold sensitizer, an oxidation number of gold is preferably either 1 or 3 and such gold sensitizers are preferably gold compounds commonly used as a gold sensitizer. As for illustrative examples thereof, chloroauric acid, potassium chloroaurate, potassium bromoaurate, auric trichloride, potassium auric thiocyanate, potassium iodoaurate, tetracyanoauric acid, ammonium aurothiocyanate, and pyridyltrichloro gold are preferable. Further, gold sensitizers described in U.S. Pat. No. 5,858,637 incorporated herein by reference and Japanese Patent Application No. 2001-79450 also can preferably be used.

In the present invention, the silver halides may be chemically sensitized in any stage after their formation but before their coating. For example, they may be chemically sensitized after desalted, but (1) before spectral sensitization, or (2) along with spectral sensitization, or (3) after spectral sensitization, or (4) just before coating. Partcularly preferably, the grains are chemically sensitized after spectral sensitization.

The amount of the sulfur, selenium or tellurium sensitizer for such chemical sensitization varies, depending on the type of the silver halide grains to be sensitized therewith and the condition for chemically ripening the grains, but may fall generally at levels of between 10⁻³ and 10⁻² mols, preferably approximately between 10⁻⁷ and 10⁻³ mols, per mol of the silver halide.

An amount of the gold sensitizer to be added varies depending on various types of conditions; however, the amount thereof is approximately in a range of from 10⁻⁷ mol to 10⁻³ mol and preferably from 10⁻⁵ mol to 5×10⁻⁴ mol per mol of the silver halide.

Though not specifically limited, the condition for chemical sensitization may be such that a pH falls between 5 and 8, a pAg falls between 6 and 11, and the temperature falls approximately between 40 and 95° C. or so.

If desired, a thiosulfonic acid compound may be added to the silver halide emulsions for use in the present invention, according to the method described in EP No.293,917.

The photosensitive silver halide grains used in the invention may be subjected to reductive sensitization. As for such reductive sensitizers, ascorbic acid and thiourea dioxide are preferable and, as other reductive sensitizers than these reductive sensitizers, stannous chloride, aminoiminomethane sulfonic acid, a hydrazine derivative, a borane compound, a silane compound, a polyamine compound and the like can preferably be used. An addition of the reductive sensitizer may be performed at any stage of a photosensitive emulsion production process of from crystalline growth to a preparation process until immediately before coating. Further, the reductive sensitization is preferably performed by ripening the grains while keeping the emulsion at pH 7 or above, or at pAg 8.3 or below; also, the reductive sensitization is preferably performed by introducing a single addition portion of silver ion during the formation of the grains.

The photosensitive silver halide used in the invention preferably contains an FED sensitizer (Fragmentable electron donating sensitizer) as a compound that generates two electrons by one photon. As the FED sensitizer, compounds described in U.S. Pat. Nos. 5,747,235, 5,747,236, 6,054,260 and 5,994,051, the disclosures of which are incorporated by reference and Japanese Patent Application No. 2001-86161 are preferably used. An addition of the FED sensitizer may be performed at any stage of a photosensitive emulsion production process of from crystalline growth to a preparation process until immediately before coating. An amount of the FED sensitizer to be added varies depending on various types of conditions; however, it is regarded approximate if the amount thereof ranges from 10⁻⁷ mol to 10⁻¹ mol, and preferably ranges from 10⁻⁶ mol to 5×10⁻² mol per mol of the silver halide.

9) Simultaneous Use of a Plurality of Silver Halides

The photosensitive material according to the present invention may contain a single kind or two or more kinds of photosensitive silver halide grains (these may differ in their mean grain size, halogen composition or crystal habit, or in the condition for their chemical sensitization), either alone or in combination. Combining two or more kinds of photosensitive silver halide grains differing in their sensitivity enables to control the gradation of the photothermographic material. The techniques relating thereto are described in JP-A NOs.57-119341, 53-106125, 47-3929, 48-55730, 46-5187, 50-73627 and 57-150841. The sensitivity difference between silver halide emulsions to be mixed is at least 0.2 logE.

10) Coating Amount

The amount of the photosensitive silver halide is preferably from 0.03 to 0.6 g/m², more preferably from 0.05 to 0.4 g/m², and most preferably from 0.07 to 0.3 g/m², in terms of the coating amount of silver per m² of the photothermographic material. Per mol of the organic silver salt, photosensitive silver halide grains to be used preferably falls between 0.01 mol and 0.5 mol, more preferably between 0.02 mol and 0.3 mol, and still more preferably between 0.03 mol and 0.2 mol.

11) Mixing of Photosensitive Silver Halide and Organic Silver Salt

Regarding the methods and the conditions for admixing the photosensitive silver halide grains with an organic silver salt having been prepared separately, employable is a method of mixing them in a high-performance stirrer, a ball mill, a sand mill, a colloid mill, a shaking mill, a homogenizer or the like; or a method of adding the photosensitive silver halide grains having been prepared to an organic silver salt in any desired timing to produce the organic silver salt. However, there is no specific limitation thereto, insofar as the methods employed provide the advantages of the present invention. Mixing two or more kinds of aqueous organic silver salt dispersions with two or more kinds of aqueous photosensitive silver salt dispersions is preferably conducted in order to suitably control the photographic properties.

12) Mixing of Silver Halide to Coating Solution

The preferred time point at which the silver halide grains are added to the coating solution to form an image-forming layer may fall between 180 minutes before coating the liquid and a time just before the coating, preferably between 60 minutes and 10 seconds before the coating. However, there is no specific limitation thereto, insofar as the methods and the conditions employed for adding the grains to the coating solution provide the advantages of the present invention. Specific mixing methods include, for example, a method of mixing the grains with the coating solution in a tank in such a controlled manner that the mean dwelling time, as calculated from an adding flow rate and a supplying flow rate to a coater, will fall within a predetermined duration; or a method of mixing them by means of a static mixer, for example, as described in “Liquid Mixing Technology” written by N. Harunby, M. F. Edwards & A. W. Nienow, Chap. 8 (translated by Koji Takahasi, published by Nikkan Kogyo Shinbun, 1989).

Binder

The binder to be used in the photosensitive layer (that is, the layer containing organic silver salts) in the photothermographic material of the present invention may be a polymer of any type, but is preferably transparent or semitransparent and is generally colorless. Preferable examples of the binder are natural resins, polymers and copolymers; synthetic resins, polymers and copolymers; and other film-forming media. More specifically, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene/maleic anhydride copolymers, styrene/acrylonitrile copolymers, styrene/butadiene copolymers, poly(vinylacetals) (e.g., poly(vinylformal) and poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). A coating layer is formed from an aqueous solution, a solution in an organic solvent or an emulsion of the binder.

The glass transition point of the binder to be included in the organic silver salt-containing layer in the present invention preferably falls between 0° C. and 80° C. (the binder of this type will hereinafter be referred to as a high-Tg binder), more preferably between 10° C. and 70° C., even more preferably between 15° C. and 60° C.

As used herein, Tg is calculated according to the following equation:
1/Tg=Σ(Xi/Tgi)

The polymer whose glass transition point Tg is calculated as above comprises n's monomers copolymerized (i indicates the number of the monomers copolymerized, falling between 1 and n); Xi indicates the mass fraction of i'th monomer (ΣXi=1); Tgi indicates the glass transition point (in terms of the absolute temperature) of the homopolymer of i'th monomer alone; and Σ indicates the sum total of i falling between 1 and n. Incidentally, the value of glass transition point (Tgi) of the homopolymer of each monomer alone is adopted from the values described in “Polymer Handbook” (3rd edition) (written by J. Brandrup, E. H. Immergut (Wiley-Interscience, 1989)).

A single kind of polymer may be used for the binder, or alternatively, two or more kinds of polymers may be used in combination. For example, a combination of a polymer having a glass transition point of higher than 20° C. and another polymer having a glass transition point of lower than 20° C. is possible. In case where at least two kinds of polymers that differ in Tg are blended for use therein, it is desirable that the mass-average Tg of the resulting blend falls within the ranges specified as above.

In case where the organic silver salt-containing layer is formed by applying a coating solution in which at least 30% by mass of the solvent is water, followed by drying, and in case where the binder to be included in the organic silver salt-containing layer is soluble or dispersible in an aqueous solvent (watery solvent), and especially when the binder to be included in the organic silver salt-containing layer is a polymer latex having an equilibrium water content of at most 2% by mass at 25° C. and 60% RH, the photothermographic material achieves improved properties. Most preferably, the binder for use in the present invention has ionic conductivity at most 2.5 mS/cm. In order to prepare such a binder, employable is a method of preparing a polymer followed by purification through a functional membrane for separation.

The aqueous solvent as used herein in which the polymer binder is soluble or dispersible in water or a mixture of water and at most 70% by mass of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” as used herein refers to polymer systems in which the polymer is not only thermodynamically dissolved but also is in the form of a dispersion.

The term “equilibrium water content at 25° C. and 60% RH” as used herein is represented by the following equation, in which W¹ indicates the mass of a polymer in humidity-conditioned equilibrium at 25° C. and 60% RH, and W⁰ indicates the absolute dry mass of the polymer at 25° C.
Equilibrium water content at 25° C. and 60% RH={(W¹−W⁰)/W⁰}×100(% by mass)

For the details of the definition of water content and the method for measuring it, for example, referred to is “Lecture of High Polymer Engineering”, No. 14, Test Methods for High Polymer Materials (by the Society of High Polymer of Japan, Chijin Shokan).

Preferably, the equilibrium water content at 25° C. and 60% RH of the binder polymer for use in the present invention is at most 2% by mass, more preferably from 0.01 to 1.5% by mass, even more preferably from 0.02 to 1% by mass.

Polymers for use in the present invention are preferably dispersible in aqueous solvents. Preferable polymer dispersions include, for example, a polymer latex in which water-insoluble hydrophobic polymer microparticles are dispersed, a dispersion in which a molecular or micellar polymer is dispersed, and the like. Any of such a polymer dispersion is preferred for use in the present invention. The particles in the polymer dispersion preferably have a mean particle size falling between 1 and 50,000 nm, more preferably between 5 and 1,000 nm, still preferably between 10 and 500 nm, and further preferably between 50 and 200 nm. The particle size distribution of the dispersed particles is not specifically limited. For example, the dispersed particles may have a broad particle size distribution, or may have a monodispersed size distribution. It is preferable to use two or more kinds of polymers having a monodispersed size distribution in order to control the nature of the coating solution.

Preferable examples of polymers which are dispersible in an aqueous solvent for use in the present invention include hydrophobic polymers such as acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked. They may be homopolymers from a single monomer, or copolymers from two or more kinds of monomers. The copolymers may be random copolymers or block copolymers. The polymers preferably have a number-average molecular weight falling between 5,000 and 1,000,000, and more preferably between 10,000 and 200,000. If too small a molecular weight of polymer is used, the mechanical strength of the image-forming layer is insufficient; in contrast, if too large a molecular weight of polymer is used, film forming properties are poor. Crosslinkable polymer latex is preferably used.

Specific Examples of Latex

Preferred examples of polymer latex for use in the present invention are mentioned below. These polymer latexes are expressed by their constituent monomers, in which each numeral in parentheses indicates the proportion, in terms of % by mass, of the monomer unit, and the molecular weight of the constituent monomers represents the number-average molecular weight. When polyfunctional monomers are used, the molecular weights of the constituent monomers are omitted and only referred to as “crosslinkable” in parentheses since the concept of molecular weight does not apply thereto. Tg indicates the glass transition point of a polymer latex.
P-1: -MMA (70)-EA(27)-MAA(3)-latex (molecular weight 37,000, Tg 61° C.)
P-2: -MMA (70)-2EHA(20)-St(5)-AA(5)- latex(molecular weight 40,000, Tg 59° C.)
P-3: -St(50)-Bu(47)-MAA(3)-latex (crosslinkable, Tg -17° C.)
P-4: -St(68)-Bu(29)-AA(3)-latex (crosslinkable, Tg 17° C.)
P-5: -St(71)-Bu(26)-IA(3)-latex (crosslinkable, Tg 24° C.)
P-6: -St(70)-Bu(27)-IA(3)-latex (crosslinkable)
P-7: -St(75)-Bu(24)-AA(1)-latex (crosslinkable, Tg 29° C.)
P-8: -St(60)-Bu(35)-DVB-(3)-MAA(2)-latex (crosslinkable)
P-9: -St(70)-Bu(25)-DVB-(2)-AA (3)-latex (crosslinkable)
P-10: -VC(50)-MMA(20)-(EA(20)-AN(5)-AA(5)-latex (molecular weight 80,000)
P-11: -VDC(85)-MMA(5)-(EA(5)-MAA(5)-latex (molecular weight 67,000)
P-12: -ET(90)-MMA(10)-latex (molecular weight 12,000)
P-13: -St(70)-2EHA(27)-AA(3) latex (molecular weight 130,000, Tg 43° C.)
P-14: -MMA(63)-EA(35)-AA(2) latex (molecular weight of 33,000, Tg 47° C.)
P-15: -St(70.5)-Bu (26.5)-AA(3)-latex (crosslinkable, Tg 23° C.)
P-16: -St(69.5)-Bu(27.5)-AA (3) latex (crosslinkable, Tg 20.5° C.)

Abbreviations of constituent monomers are as follows: MMA: methyl methacrylate; EA: ethyl acrylate; MAA: methacrylic acid; 2EHA: 2-ethylhexyl acrylate; St: styrene; Bu: butadiene; AA: acrylic acid; DVB: divinylbenzene; VC: vinyl chloride; AN: acrylonitrile; VDC: vinylidene chloride; Et: ethylene; IA: itaconic acid The polymer latexes mentioned above are commercially available. Some available products employed in the present invention are mentioned below. Examples of acrylic polymers include CEBIAN A-4635, 4718 and 4601 (produced by Daicel Chemical Industries), and NIPOL Lx811, 814, 821, 820 and 857 (produced by Nippon Zeon); examples of poly(esters) include FINETEX ES650, 611, 675 and 850 (produced by Dai-Nippon Ink & Chemicals), and WD-size and WMS (produced by Eastman Chemical); examples of poly(urethanes) include HYDRAN AP10, 20, 30 and 40 (produced by Dal-Nippon Ink & Chemicals); examples of rubbers include LACSTAR 7310K, 3307B, 4700H and 7132C (produced by Dai-Nippon Ink & Chemicals), and Nipol Lx416, 410, 438C and 2507 (produced by Nippon Zeon); examples of poly(vinyl chlorides) include G351 and G576 (produced by Nippon Zeon); examples of poly(vinylidene chlorides) include L502 and L513 (produced by Asahi Kasei); and examples of poly(olefins) include CHEMIPEARL S120 and SA100 (produced by Mitsui Petrochemical).

These polymer latexes may be used either singly or, as necessary, in combination of two or more.

Preferable Latex

Particularly preferable polymer latex for use in the present invention is styrene/butadiene copolymer latex. In the styrene/butadiene copolymer, the ratio of styrene monomer unit to butadiene monomer unit preferably falls between 40/60 and 95/5 by mass. Further, the proportion of styrene monomer unit and butadiene monomer unit preferably accounts for from 60 to 99% by mass of the copolymer. The preferred range of the molecular weight of the copolymer is the same as described above. The polymer latex of the invention contains acrylic acid or methacrylic acid, preferably, by 1 to 6% by mass and, more preferably, by 2 to 5% by mass to the sum of styrene and butadiene. The polymer latex of the invention preferably contains acrylic acid. A preferred range of the molecular weight is identical with that described above.

Preferred styrene/butadiene copolymer latexes for use in the present invention are the above-mentioned P-3 to P-8, P-14 and P-15, and commercially available products, LACSTAR-3307B, 7132C, and NIPOL Lx416.

The organic silver salt-containing layer of the photothermographic material of the present invention may optionally contain a hydrophilic polymer serving as a binder, such as gelatin, polyvinyl alcohol, methyl cellulose, hydroxypropyl cellulose and the like. The amount of the hydrophilic polymer to be included in the layer is preferably at most 30% by mass, and more preferably at most 20% by mass of the total binder in the organic silver salt-containing layer.

It is preferable to use a polymer latex as the binder for forming the organic silver salt-containing layer (that is, the image-forming layer) of the photothermographic material of the present invention. Specifically, the binder is used in the organic silver salt-containing layer in a ratio of a total binder/an organic silver salt falling between 1/10 and 10/1, more preferably between 1/3 and 5/1 by mass, and most preferably between 1/1 and 3/1 by mass.

The organic silver salt-containing layer is a photosensitive layer (an emulsion layer) which generally contains a photosensitive silver salt, that is, a photosensitive silver halide. In the layer, the ratio of total binder/silver halide preferably falls between 5 and 400, and more preferably between 10 and 200 by mass.

The overall amount of the binder in the image-forming layer of the photothermographic material of the present invention preferably falls between 0.2 and 30 g/m², more preferably between 1 and 15 g/m², and still further preferably between 2 and 10 g/m². The image-forming layer may optionally contain a crosslinking agent, and a surfactant for improving the coatability of the coating solution.

Preferred Solvent for Coating Solution

The solvent for the coating solution of the organic silver salt containing layer of the photosensitive material in the invention (for the sake of simplicity, the solvent and the dispersion medium are collectively referred to as solvent) is preferably an aqueous solvent containing 30% by mass or more of water. As the ingredient other than water, any water miscible organic solvent such as methyl alcohol, ethyl alcohol, isopropyl alcohol, methyl cellosolve, ethyl cellosolve, dimethyl formamide, and ethyl acetate may be used. The water content in the solvent is, preferably, 50% by mass or more and, more preferably, 70% by mass or more. Preferred examples for the solvent composition may include water, as well as water/methyl alcohol=90/10, water/methyl alcohol=70/30, water/methyl alcohol/dimethylformamide=80/15/5, water/methyl alcohol/ethyl cellosolve=85/10/5 and water/methyl alcohol/isopropyl alcohol=85/10/5 (numerical value based on % by mass).

Anti-Foggant

The anti-foggant, the stabilizer and the stabilizer precursor usable in the invention may include compounds described in JP-A No.10-62899, column No.0070, EP-A No. 0803764A1, page 20, line 57-page 21, line 7, compounds described in JP-A Nos. 9-281637 and 9-32984, compounds described in U.S. Pat. Nos. 6,083,681 and 6,083,681 the disclosures of which are incorporated by reference, and EP No. 1048975. Further, the anti-foggant preferably used in the invention is an organic halogen compound and includes those disclosed in JP-A No. 11-65021, column Nos. 0111 to 0112. Particularly, the organic halogen compound represented by the formula (P) in JP-A No. 2000-284399, the organic polyhalogen compound represented by the general formula (II) in JP-A No. 10-339934 and the organic polyhalogen compounds described in JP-A Nos. 2001-31644 and 2001-33911 are preferred.

Polyhalogen Compound

Preferred organic polyhalogen compounds in the invention are to be described specifically. The preferred polyhalogen compound in the invention is a compound represented by formula (H).
Q-(Y)ₙ—C(Z₁)(Z₂)X Formula (H)

In formula (H), Q represents an alkyl group, aryl group or heterocyclic group, Y represents a bivalent connection group, n represents 0 or 1, Z₁ and Z₂ each represent a halogen atom and X represents a hydrogen atom or an electron attractive group.

In formula (H), Q is preferably an aryl group or heterocyclic group. In a case where Q is a heterocyclic group in formula (H), a nitrogen-containing heterocyclic group containing 1 or 2 nitrogen atom is preferred, with 2-pyridyl group and 2-quinolyl group being particularly preferred.

In a case where Q is an aryl group in formula (H), Q preferably represents a phenyl group substituted with an electron attractive group having a positive value as Hammett's substituent constant σₚ. For the Hammett's substituent constant is taught in the Journal of Medicinal Chemistry, 1973, vol. 16, No. 11, pages 1207-1216. The electron attractive group described above may include, for example, halogen atom (fluorine atom (σp value: 0.06), chlorine atom (σp value: 0.23), bromine atom (σp value: 0.23), iodine atom (σp value: 0.18)), trihalomethyl group (tribromomethyl (σp value: 0.29), trichloromethyl (σp value: 0.33), trifluoromethyl (σp value: 0.54)), cyano group (σp value: 0.66), nitro group (σp value: 0.78), aliphatic, aryl or heterocyclic sulfonyl group (for example, methanesulfonyl (σp value: 0.72)), aliphatic, aryl or heterocyclic acyl group (for example, acetyl (σp value: 0.50), benzoyl (σp value: 0.43)), alkinyl group (for example, C═CH (σp value: 0.23)), aliphatic group, aryl or heterocyclic oxycarbonyl group (for example, methoxy carbonyl (σp value: 0.45), phenoxycarbonyl (σp value: 0.44)), carbamoyl group (σp value: 0.36), sulfamoyl group (σp value: 0.57), sulfoxide group, heterocyclic ring and phosphoryl group. The σp value is preferably in a range from 0.2 to 2.0 and, more preferably, 0.4 to 1.0. Particularly, preferred electron attractive groups are a carbamoyl group, alkoxycarbonyl group, alkylsulfonyl group, and alkylphosphoryl group, with a carbamoyl group being most preferred among them.

X is preferably an electron attractive group and, more preferably, a halogen atom, aliphatic aryl or heterocyclic sulfonyl group, aliphatic, aryl or heterocyclic acyl group, aliphatic, aryl or heterocyclic oxycarbonyl group, carbamoyl group, and sulfamoyl group and, particularly preferably, a halogen atom. Among the halogen atoms, preferred are a chlorine atom, a bromine atom and iodine atom, and further preferred are chlorine atom and bromine atom, with a bromine atom being particularly preferred.

Y represents, preferably, —C(═O)—, —SO— or —SO₂— and, more preferably, —C(═O)—, and —SO₂— and, particularly preferably, —SO₂—. n represents 0 or 1 and, preferably, 1.

Specific examples of the compound represented by formula (H) of the invention are shown below.

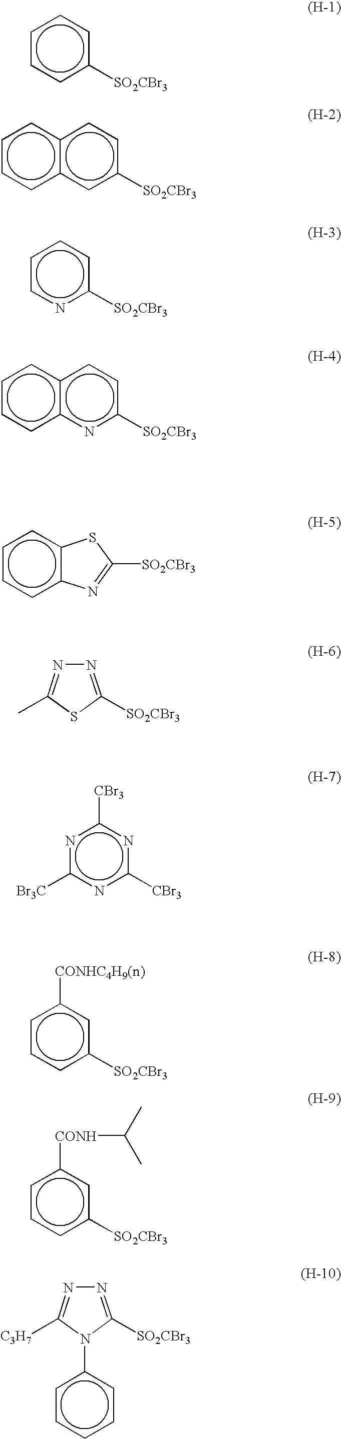

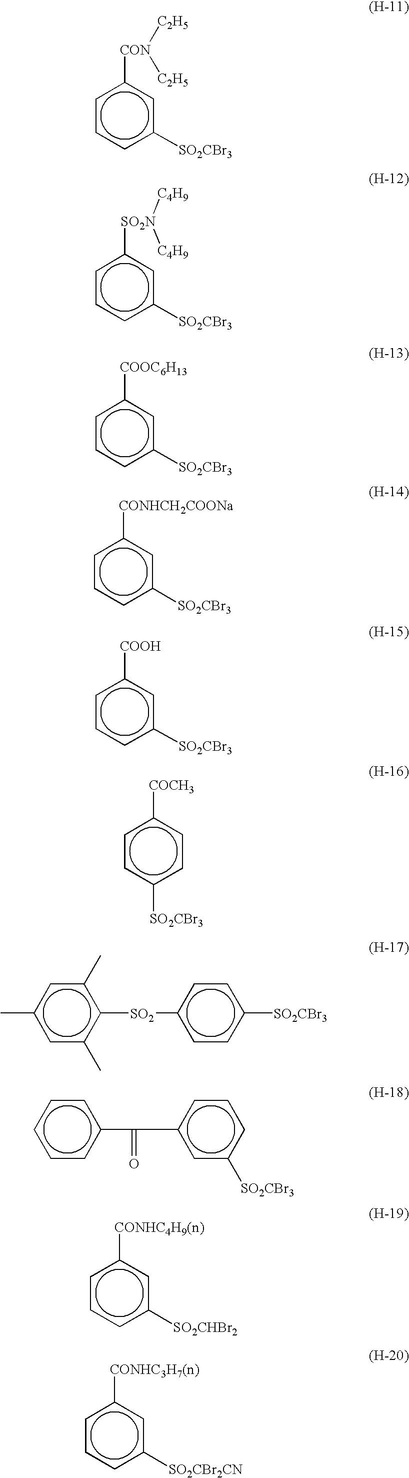

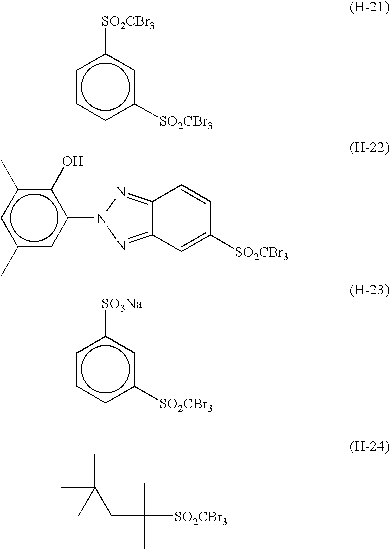

Other preferred polyhalogen compounds for use in the present invention include the compounds described in JP-A Nos. 2001-31644, 2001-56526 and 2001-209145.

The compound represented by formula (H) in the invention is used within a range, preferably, from 10⁻⁴ to 1 mol, more preferably, 10⁻³ to 0.5 mol and, further preferably, 1×10⁻² to 0.2 mol based on one mol of the non-photosensitive silver salt in the image-forming layer.

In the invention, the method of incorporating the anti-foggant in the photosensitive material may include the method described for the method of incorporating the reducing agent, and also the organic polyhalogen compound is added preferably as a solid microparticle dispersion.

Other Anti-Foggants

Other anti-foggants may include mercury (II) salt in JP-A No. 11-65021; column No. 0113, benzoic acid in column No. 0114 of the publication, salicylic acid derivatives in JP-A No. 2000-206642, formalin scavenger compound represented by the formula (S) in JP-A No. 2000-221634, triazine compound according to claim 9 in JP-A No. 11-352624, the compound represented by the general formula (III) in JP-A No. 6-11791 and 4-hydroxy-6-methyl-1,3,3a,7-tetrazaindene.

The photothermographic material in the invention may contain an azolium salt with an anti-fogging purpose. The azolium salt may include the compound represented by the general formula (XI) described in JP-A No. 59-193447, the compound described in JP-B No. 55-12581, and the compound represented by the general formula (II) described in JP-A No. 60-153039. The azolium salt may be added to any portion of the photosensitive material and it is preferred to add it as an addition layer to the layer on the surface having the photosensitive layer and it is further preferred to add to the organic silver salt containing layer. Referring to the addition time of the azolium salt, it may be added it at any step for the preparation of the coating solution and, in a case of adding to the organic silver salt containing layer, it may be added at any step from preparation of the organic silver salt to preparation of the coating solution and it is preferably added from the preparation of organic silver salt to just before coating thereof. The azolium salt may be added by any method such as in the form of powder, solution and fine particle dispersion. Further, it may be added as a solution mixed with other additives such as a sensitizing dye, a reducing agent, or a toning agent. The addition amount of the azolium salt in the invention may be any amount and it is, preferably, 1×10⁻⁶ mol or more and 2 mol or less and, further preferably, 1×10⁻³ mol or more and 0.5 mol or less based on one mol of silver.

Other Additives

1) Mercapto, Disulfide and Thions

In the invention, for controlling the development by suppressing or promoting development, for improving the spectral sensitizing efficiency and improving the storability before and after development, mercapto compound, disulfide compound and thion compound may be incorporated. Exemplary compounds are disclosed in JP-A No. 10-62899: column Nos. 0067 to 0069, the compound represented by the general formula (I) of JP-A No. 10-186572 and those of specific examples in column Nos. 0033 to 0052 thereof, EP-A No. 0803764A1, page 20, lines 36 to 56. Mercapto substituted heterocyclic aromatic compounds described in JP-A Nos. 9-297367, 9-304875, 2001-100358, and Japanese Patent Application Nos. 2001-104213 and 2001-104214 are preferred.

2) Toning Agent

In the photothermographic material of the invention, a toning agent is added preferably and the toning agent is described in JP-A No. 10-62899, column Nos. 0054 to 0055, EP-A No. 0803764A1 in page 21, lines 23-48, JP-A Nos. 2000-356317 and 2000-187298 may be used. Particularly, phthalazinones (phthalazinone, phthalazinone derivatives or metal salts; for example, 4-(1-naphthyl) phthalazinone, 6-chlorophthalazinone, 5,7-dimetoxyphthalazinone and 2,3-dihydro-1,4-phthalazione); combinations of phthalazinones and phthalic acids (for example, phthalic acid, 4-methyl phthalic acid, 4-nitro phthalic acid, diammonium phthalate, sodium phthalate, potassium phthalate, and tetrachloro phthalic acid anhydride); phthalazines (phthalazine, phthalazine derivative or metal salts; for example, 4-(1-naphthyl)phthalazine, 6-isopropyl phthalazine, 6-t-butyl phthalazine, 6-chlorophthalazine, 5,7-dimethoxyphthalazine and 2,3-dihydrophthalazine); a combination of phthalazines and phthalic acids are preferred and, the combination of phthalazines and phthalic acids is particularly preferred. Among them particularly preferred is a combination of 6-isopropyl phthalazine and phthalic acid or 4-methylphthalic acid.

3) Plasticizer and Lubricant

The plasticizer and the lubricant usable for the photosensitive layer of the invention are described in JP-A No. 11-65021, column No. 0117, and the super contrast enhancing agent for forming super contrast images or the addition method thereof are described as compounds of the formula (H), formulae (1)-(3), and formulae (A) and (B) in the same publication in column No. 0118, JP-A No. 11-223898, column Nos. 0136 to 0193, and JP-A No. 2000-284399, compounds of the general formulae (III)-(V) described in Japanese Patent Application No. 11-91652 (specific compounds: Chem 21-Chem 24), and contrast promotor is described in JP-A No. 11-65021, column No. 0102 and JP-A No. 11-223898, column Nos. 0194 to 0195.

4) Dye and Pigment

In the photosensitive layer of the invention, various kinds of dyes and pigments (for example, C.I. Pigment Blue 60, C.I. Pigment Blue 64, C.I. Pigment Blue 15:6) may be used for improving the tone, preventing the occurrence of interference fringes upon laser exposure and prevention of irradiation. They are specifically described in WO98/36322, and JP-A Nos. 10-268456 and 11-338098.

5) Ultra-High Contrast Agent

An ultra-high contrast agent is preferably added to the image-forming layer for forming ultra-high contrast images suitable to print making applications. The ultra-high contrast agent, the addition method and the addition amount are described as the compounds of the formula (H), formulae (1)-(3) and formulae (A), (B) in JP-A No. 11-65021, column No. 0118, in JP-A No. 11-223893, column Nos. 0136 to 0193, in the specification of Japanese Patent Application No. 11-87297, the compounds of the general formulae (III)-(V) in the specification of Japanese Patent Application No. 11-91652 (specific compounds: Chem 21-Chem 24), and the contrast enhancing promotor is described in JP-A No. 11-65021, column No. 0102 and JP-A No. 11-223898, column Nos. 0194 to 0195.

In case where a formic acid or the salt thereof is used as a strong fogging agent in the present invention, it may be added to an image-forming layer of the material containing the photosensitive silver halide in an amount of preferably at most 5 mmols, and more preferably at most 1 mmol per mol of silver.

In case where an ultra-high contrast agent is used in the photothermographic material of the present invention, it is preferably used in combination with an acid or the salt thereof formed by hydration of diphosphorus pentaoxide. The acid and the salts thereof to be formed through hydration of diphosphorus pentaoxide include, for example, metaphosphoric acid (and its salts), pyrophosphoric acid (and its salts), orthophosphoric acid (and its salts), triphosphoric acid (and its acid), tetraphosphoric acid (and its salts), and hexametaphosphoric acid (and its salts). For the acid and the salt thereof to be formed through hydration of diphosphorus pentaoxide, preferably mentioned are orthophosphoric acid (and its salts), and hexametaphosphoric acid (and its salts). Specific examples of the salts are sodium orthophosphate, sodium dihydrogen-orthophosphate, sodium hexametaphosphate, and ammonium hexametaphosphate.

The amount of the acid to be formed through hydration of diphosphorus pentaoxide or the salt thereof to be added in the invention (that is, the coating amount thereof per m² of the photothermographic material) preferably falls between 0.1 and 500 mg/m², and more preferably between 0.5 and 100 mg/m².

The reducing agent, the hydrogen bond-forming compound, the development accelerator, and the polyhalogen compound in the invention are used preferably as a solid dispersion, and a preferred production method of the solid dispersion is described in JP-A No. 2002-55405.

Preparation and Coating of Coating Solution

The temperature at which the coating solution for the image-forming layer is prepared preferably falls between 30° C. and 65° C., more preferably between 35° C. and 60° C. or lower, and even more preferably between 35° C. and 55° C. Further, the temperature of the coating solution is preferably maintained between 30° C. and 65° C. immediately after a polymer latex has been added thereto. Still further, it is preferable that a reducing gent has been mixed with an organic silver salt before a polymer latex is added.

Layer Construction and Components

The image-forming layer is provided on the support in a mono-layered or multi-layered construction. In case where the image-forming layer has a mono-layered construction, the layer contains an organic silver salt, a photosensitive silver halide, a reducing agent and a binder, and additionally as desired, a toning agent, a coating aid and other auxiliaries. In case where the image-forming layer has a two or more layered construction, the first image-forming layer (usually, this is directly adjacent to the support) must contain an organic silver salt and a photosensitive silver halide, and the second image-forming layer or the both layers must contain additional several ingredients. The multi-color photothermographic material may have a combination of these two layers for respective colors, or alternatively the material may contain all the essential ingredients in a single layer as disclosed in U.S. Pat. No. 4,708,928. In case of multi-color photothermographic material using a plurality of dyes, the respective emulsion layers are usually partitioned one another with a functional or non-functional barrier layer between the adjacent photosensitive layers as disclosed in U.S. Pat. No. 4,460,681.

The photothermographic material of the invention may have a non-photosensitive layer in addition to the image-forming layer. The non-photosensitive layer may be classified in view of the arrangement thereof into (a) a surface protective layer disposed on the image-forming layer (on the side remote from a support), (b) an intermediate layer disposed between a plurality of image-forming layers or between a image-forming layer and a protection layer, (c) a undercoat layer disposed between the image-forming layer and the support and (d) a back layer disposed on the side opposite to the image-forming layer.

Further, a layer that functions as an optical filter may be provided and this is disposed as the layer (a) or (b). An anti-halation layer is disposed as the layer (c) or (d) in the photosensitive material.

1) Surface Protective Layer

In the photothermographic material according to the invention, a surface protective layer may be provided with an aim of preventing deposition of the image-forming layer. The surface protective layer may comprise a single layer or plural layers. The surface protective layer is described in JP-A No. 11-65021, column Nos. 0119 to 0120 and JP-A No. 2000-171936.

The binder for the surface protective layer of the invention is preferably gelatin and it is also preferred to use polyvinyl alcohol (PVA) alone or in combination. As gelatin, inert gelatin (for example, Nitta gelatin 750), or phthalized gelatin (for example, Nitta gelatin 801) may be used. PVA may include those described in JP-A No. 2000-171936, column Nos. 0009 to 0020, and they include, preferably, wholly saponified product PVA-105 and partially saponified product PVA-205 or PVA-335, and modified polyvinyl alcohol MP-203 (all are trade names of products manufactured by Kuraray Co.). The coating amount of the polyvinyl alcohol (per m² of support) for the protection layer (per one layer) is, preferably, 0.3 to 4.0 g/m² and, more preferably, 0.3 to 2.0 g/m².

The coating amount (per m² support) of the entire binder (containing water soluble polymer and latex polymer) in the surface protective layer (per one layer) is, preferably, from 0.3 to 5.0 g/m² and, more preferably, 0.3 to 2.0 g/m².

2) Anti-Halation Layer

In the photothermographic material of the invention, an anti-halation layer may be disposed to the photosensitive layer on the side remote from an exposure light source.

The anti-halation layer is described in JP-A No.11-65021, column Nos. 0123 to 0124, JP-A Nos. 11-223898, 9-230531, 10-36695, 10-104779, 11-231457, 11-352625 and 11-352626.

The anti-halation layer includes an anti-halation dye having absorption at an exposure wavelength. In a case where the exposure wavelength is in an infrared region, an infrared absorption dye may be used and, in this case, a dye not having absorption in a visible region is preferred.

In a case of preventing halation by using a dye having absorption in a visible region, it is preferred that the color of the dye does not substantially remain after image formation, and a color discharging means by the heat of thermal development is preferably used. Particularly, it is preferred to add a thermally color discharging dye and a base precursor to the non-photosensitive layer and causing the same to act as an anti-halation layer. The techniques are described, for example, in JP-A No. 11-231457.

The addition amount of the color discharging dye is determined depending on the application of the dye. Generally, it is used in an amount such that the optical density (absorption) exceeds 0.1 when measured at an aimed wavelength. The optical density is, preferably, from 0.15 to 2 and, more preferably, 0.2 to 1. The amount of the dye used for obtaining such an optical density is generally about 0.001 to 1 g/m².

When the color of the dye is discharged, the optical density after the thermal development may be lowered to 0.1 or less. Two or more kinds of dischargeable dyes may be used in combination for the heat dischargeable recording material or photothermographic material. In the same manner, two or more kinds of base precursors may be used in combination.

In the thermal discharging using the dischargeable dye and the base precursor described above, it is preferred to use a substance that lowers the melting point by 3° C. (deg) or more when mixed with the base precursor as described in JP-A No. 11-352626 (e.g., diphenyl sulfone, 4-chlorophenyl(phenyl)sulfone) and 2-naphthyl benzoate in combination in view of thermal discharging property.

3) Back Layer

The back layer applicable to the invention is described in JP-A No. 11-65021, column Nos. 0128 to 0130.

In the invention, a coloring agent having an absorption maximum at 300-450 nm may be added with an aim of improving the aging change of silver tone and images. The coloring agent is described, for example, in JP-A Nos. 62-210458, 63-104046, 63-103235, 63-208846, 63-306436, 63-314535, 01-61745, and JP-A No. 2001-100363.

The coloring agent is usually added within a range from 0.1 mg/m² to 1 g/m² and it is added, preferably, to a back layer disposed on the side opposite to the photosensitive layer.

Further, for controlling the basic tone, it is preferred to use a dye having an absorption peak at 580 to 680 nm. As the dye for this purpose, for azomethine type oil soluble dye with small absorption intensity on the side of short wavelength described in JP-A Nos. 04-359967 and 04-359968, and phthalocyanine type water soluble dyes described in Japanese Patent Application No. 2002-96797 are preferred. The dye for this purpose may be added to any layer and it is more preferred to be added to the non-photosensitive layer on the emulsion surface or back surface.

The photothermographic material in the invention is preferably a so-called single-sided photosensitive material having at least one layer of a silver halide emulsion on one side of a support and a back layer on the other side thereof.

4) Matting Agent

In the invention, a matting agent is preferably added for the improvement of the transportability and the matting agent is described in JP-A No. 11-65021, column Nos. 0126 to 0127. The coating amount of the matting agent per 1 m² of the photosensitive material is, preferably, 1 to 400 mg/m² and, more preferably, 5 to 300 mg/m².

The shape of the matting agent in the invention may be a definite or indefinite shape and a definite and spherical shape is used preferably. The average particle size is within a range, preferably, from 0.5 to 10 μm, more preferably, 1.0 to 8.0 μm and, further preferably, 2.0 to 6.0 μm. The fluctuation coefficient of the size distribution is, preferably, 50% or less, more preferably, 40% or less and, further preferably, 30% or less. The fluctuation coefficient is a value represented by: (standard deviation of particle size)/(average value of particle size)×100. Further, it is also preferred to use two kinds of matting agents each of small fluctuation coefficient, with the ratio of the average particle size of 3 or more.

The matte degree of the emulsion surface may be at any level so long as it is free from star dust surface defects. It is preferred that the Beck's smoothness is 30 sec or more and 2,000 sec or less and, particularly preferably, 40 sec or more and 1,500 sec or less. The Beck's smoothness may be determined easily according to Japanese Industry Standards (JIS) P8119 “Smoothness test method for paper and paper board by a Beck tester” and according to TAPPI standard method T479.

The matte degree of the back layer in the invention is such that the Beck smoothness is, preferably, 1200 sec or less and 10 sec or more and, more preferably, 800 sec or less and 20 sec or more and, further preferably, 500 sec or less and 40 sec or more.

In the invention, the matting agent is contained preferably in the outermost surface layer or a layer that functions as the outermost surface layer, or a layer nearer to the outer surface of the photosensitive material, or it is preferably contained in the layer that functions as a so-called protective layer.

5) Polymer Latex

A polymer latex is preferably used for the surface protective layer or the back layer, when the photothermographic material of the invention is used for printing application in which dimensional change particularly causes a problem. The polymer latex is also described in “Synthetic Resin Emulsion (edited by Taira Okuda, Hiroshi Inagaki, published from High Molecule Publishing Society (1978))”, “Application of Synthetic Latex Synthetic Latex (edited by Takaaki Sugimura, Yasuo Kataoka, Soichi Suzuki and Keiji Kasahara, published from High Molecule Publishing Society (1993))”, “Chemistry of Synthetic Latex (written by Soichi Muroi, Published from High Molecule Publishing Society (1970))” and may include specifically, a latex of methyl methacrylate (33.5% by mass)/ethyl acrylate (50% by mass)/methacrylic acid (16.5% by mass) copolymer, a latex of methyl methacrylate (47.5% by mass)/butadiene (47.5% by mass)/itaconic acid (5% by mass) copolymer, a latex of ethyl acrylate/methacrylic acid copolymer, a latex of methyl methacrylate (58.9% by mass)/2-ethylhexyl acrylate (25.4% by mass)/styrene (8.6% by mass)/2-hydroxyethyl methacrylate (5.1% by mass)/acrylic acid (2.0% by mass) copolymer, and a latex of methyl methacrylate (64.0% by mass)/styrene (9.0% by mass)/butyl acrylate (20.0% by mass)/2-hydroxyethyl methacrylate (5.0% by mass)/acrylic acid (2.0% by mass) copolymer. As the binder for the surface protective layer, it may be applied a combination of polymer latexes may be applied as described in the specification of Japanese Patent Application No. 11-6872, technique described in the specification of JP-A No. 2000-267226, column Nos. 0021 to 0025, technique described in the specification of Japanese Patent Application No. 11-6872, column Nos. 0027 to 0028, and technique described in the specification of JP-A No. 2000-19678, column Nos. 0023 to 0041. The ratio of the polymer latex of the surface protective layer is, preferably, 10% by mass or more and 90% by mass or less and, particularly preferably, 20% by mass or more and 80% by mass or less based on the entire binder.

6) Film Surface pH

In the photothermographic material of the invention, the pH at the film surface before the thermal development is, preferably, 7.0 or less and, more preferably, 6.6 or less. While there is no particular restriction to the lower limit, a lower limit of about 3 is preferred. A most preferred pH range is within a range from 4 to 6.2. In order to control the film surface pH, it is preferred to use a non-volatile acid such as an organic acid, for example, a phthalic acid derivative and sulfuric acid, and a volatile base such as ammonia, with a view towards reducing the film surface pH. Particularly, since ammonia is easily volatile and may be removed before coating step or thermal development, it is preferred for attaining the low film surface pH.

Further, it is also adopted preferable to use a non-volatile base such as sodium hydroxide, potassium hydroxide and lithium hydroxide in combination with the ammonia. The measuring method for the film surface pH is described in the specification of JP-A No. 2000-284399, column No. 0123.

7) Hardening Agent

A hardening agent may be used in each of the layers such as the photosensitive layer, the protection layer and the back layer of the invention. Examples of the hardening agent include those described in “THE THEORY OF THE PHOTOGRAPHIC PROCESS FOURTH EDITION”, written by T. H. James (Published from Macmillan Publishing Co., Inc. in 1977), in pages 77 to 87, and they may include chrome alum, sodium salt of 2,4-dichloro-6-hydroxy-s-triazine, N,N-ethylenebis(vinylsulfone acetoamide), N,N-propylenebis(vinylsulfone acetoamide), as well as polyvalent metal ions described in page 78 of the literature, polyisocyanates described in U.S. Pat. No. 4,281,060 and JP-A No. 6-208193, epoxy compounds described, for example, in U.S. Pat. No. 4,791,042 and vinylsulfonic compounds in JP-A No. 62-89048.

The hardening agent is added as a solution and the addition timing of the solution into the protection layer coating solution is from 180 min before to just before the coating and, preferably, from 60 min to 10 sec before the coating. The mixing method and the mixing condition have no particular restrictions so long as the effect of the invention may sufficiently be attained. The specific mixing method may include a method in a tank adapted such that the average residence time calculated based on the addition flow rate and the liquid delivery amount to the coater is controlled to a desired time, or a method of using a static mixer as described in “Liquid Mixing Technology”, written by N. Harnby, M. F. Edwards, A. W. Nienow, and translated by Koji Takahashi (published from Nikkan Kogyo Shinbun-sha in 1989) in Chapter 8.

8) Surfactant

The surfactant applicable in the invention is described in JP-A No. 11-65021, column No. 0132, the solvent is described in the same publication, in column No. 0133, the support is described in the same publication, column No. 0134, the anti-static or conductive layer is described in the same publication in column No. 0135, the method of obtaining color images is described in the same publication in column No. 0136 and the sliding agent is described in JP-A No. 11-84573, column Nos. 0061 to 0064 and Japanese Patent Application No. 11-106881, column Nos. 0049 to 0062.

In the invention, a fluoro surfactant is preferably used. Examples of the fluoro surfactant may include those compounds described in JP-A Nos. 10-197985, 2000-19680, and 2000-214554. Further, a polymeric fluoro surfactant described in JP-A No. 09-281636 is also preferably used. In the photothermographic material of the invention, it is preferred to use the fluoro surfactants described in JP-A No. 2002-82411, Japanese Patent Application Nos. 2001-242357 and 2001-264110. Particularly, the fluoro surfactants described in Japanese Patent Application Nos. 2001-242357 and 2001-264110 are preferred in view of the charge controlling performance, the stability for the state of coated surface and the slidability when coating and production are conducted by using an aqueous coating solution. Moreover, the fluoro solvent described in Japanese Patent Application No. 2001-264110 is most preferred since the charge controlling performance is high and the amount of use may be decreased.

In the invention, the fluorine-type surfactant may be used on the emulsion surface and/or the back surface, and it is preferably used on both of the surfaces. Further, it is particularly preferred to use in combination with the conductive layer containing the metal oxide described above. In this case, sufficient performance may be obtained even when the use amount of the fluorine-type surfactant is decreased or use thereof is obviated on the surface having the conductive layer.

The preferred amount of the fluorine-type surfactant used is within a range of 0.1 mg/m² to 100 mg/m², more preferably, 0.3 mg/m² to 30 mg/m² and, further preferably, 1 mg/m² to 10 mg/m² to each of the emulsion surface and the back surface. Particularly, the fluorine-type surfactant described in Japanese Patent Application No. 2001-264110 is a highly effective and it is used within a range, preferably, from 0.01 to 10 mg/m² and, more preferably, 0.1 to 5 mg/m².

9) Anti-Static Agent

In the invention, it is preferred to provide a conductive layer containing a metal oxide or conductive polymer. The anti-static layer may be disposed also as an undercoat layer and a back layer surface protective layer, and it may be disposed separately. For the conductive material of the anti-static layer, it is preferable to use a metal oxide, the conductivity of which is improved by introducing oxygen defects or hetero metal atoms in the metal oxide. As an example of the metal oxide, ZnO, TiO₂, and SnO₂ are preferred, and addition is conducted preferably by using, for example, the addition of Al or In to ZnO, the addition of Sb, Nb, P and halogen element to SnO₂, and the addition of Nb, Ta to TiO₂. Sb added SnO₂ is particularly preferred. The addition amount of the hetero atom is within a range, preferably, from 0.01 to 30 mol %, more preferably, 0.1 to 10 mol %. The shape of the metal oxide may be spherical, acicular or plate-like, and it is preferable to use acicular particles with a major axis/minor axis ratio of 2.0 or more, preferably, 3.0 to 50 with a view point of providing conductivity. The amount of the metal oxide used is within a range, preferably, from 1 mg/m² to 1000 mg/m², more preferably, 10 mg/m² to 500 mg/m² and, further preferably, 20 mg/m² to 200 mg/m². The anti-static layer of the invention may be disposed on either the side of the emulsion surface or the side of the back surface, but it is preferably disposed between the support and the back layer. Specific examples of the anti-static layer of the invention are described in JP-A No. 11-65021, column No. 0135, JP-A Nos. 56-143430, 56-243431, 58-62646, 56-120519 and JP-A No. 11-84573, column Nos. 0040 to 0051, U.S. Pat. No. 5,575,957, and JP-A No. 11-223898, column Nos. 0078 to 0084.

10) Support

For the transparent support, polyester, particularly polyethylene terephthalate having undergone heat treatment in a temperature range from 130 to 185° C., is used preferably for moderating internal strains remaining in the film upon biaxial stretching and eliminating heat shrinkage strains caused during thermal development. In the case of a photothermographic material for medical use, the transparent support optionally may be colored by a blue dye (e.g., Dye-1 described in Examples of JP-A No. 8-240877).

It is preferable to employ on the support undercoating techniques of a water soluble polyester as described in JP-A No. 11-84574, styrene-butadiene copolymer as described in JP-A No. 10-186565, or vinyliden chloride copolymer as described in JP-A No. 2000-39684 and Japanese Patent Application No. 11-106881, column Nos. 0063 to 0080. The water content of the support is preferably 0.5 wt % or less when the emulsion layer or the back layer is coated on the support.

11) Other Additives

For the photothermographic material, an antioxidant, stabilizer, plasticizer, UV-ray absorbent or coating aid may further be added. Each of the additives is added either to the photosensitive layer or to the non-photosensitive layer. In this regard, reference may be made to WO98/36322, EP-A 803764A1, JP-A Nos. 10-186567 and 10-18568.

12) Coating Method

The photothermographic material of the invention may be coated by any suitable method. Specifically, various coating operations including extrusion coating, slide coating, curtain coating, dip coating, knife coating, flow coating or an extrusion coating using a hopper of the type as described in U.S. Pat. No. 2,681,294 are used. Extrusion coating or slide coating described in “LIQUID FILM COATING” written by Stephen F. Kistler, Peter M. Schweizer (published from Chapman and Hall Co. in 1997) from pages 399 to 536 is used preferably and the slide coating is used particularly preferably. An example for the shape of the slide coater used for slide coating is shown in FIG. 11b.1 on page 427. Further, two or more layers may be coated simultaneously by the method described in pages 399 to 536 of Liquid Film Coating and the method described in U.S. Pat. No. 2,761,791 and British Patent No. 837,095. Particularly, preferred coating methods employed in the invention are described in JP-A Nos. 2001-194748, 2002-153808, 2002-153803, and 2002-182333.

The coating solution for the organic silver salt containing layer in the invention is, preferably, a so-called thixotropic fluid. For the technique, reference may be made to JP-A No. 11-52509. The viscosity at a shearing rate of 0.1 S⁻¹ of the coating solution for the organic silver containing layer is preferably 400 mPa·s or more and 100,000 mPa·s or less and, more preferably, 500 mPa·s or more and 20,000 mPa·s or less. Further, at the shearing rate of 1,000 S⁻¹, it is preferably 1 mPa·s or more and 200 mPa·s or less and, more preferably, 5 mPa·s or more and 80 mPa·s or less.

When two kinds of solutions are mixed to prepare a coating solution of the invention, well-known inline mixers and implant mixers are preferably used. A preferred inline mixer for the invention is described in JP-A No. 2002-85948 and an implant mixer is described in JP-A No. 2002-90940.

A defoaming treatment is applied preferably for the coating solution in the invention in order to promote surface uniformity. A preferred defoaming method is described in JP-A No. 2002-66431.

When the coating solution of the invention is coated, charge elimination is preferably applied in order to prevent deposition of dust and darts caused by charging to the support. An example of a preferred charge elimination method in the invention is described in JP-A No. 2002-143747.

In the invention, it is important to accurately control the drying process and the drying temperature when drying the non-setting image-forming layer coating solution. A preferred drying method in the invention is described specifically in JP-A Nos. 2001-194749 and 2002-139814.

In order to improve the film-forming property of the photothermographic material of the invention, heat treatment is preferably carried out just after coating and drying. The temperature for the heat treatment is preferably within a range from 60° C. to 100° C. (the film surface temperature), and the heating time is preferably within a range from 1 sec to 60 sec. A more preferred range for the film surface temperature is from 70 to 90° C. and from 2 to 10 sec for the heating temperature. The preferred heat treatment method in the invention is described in JP-A No. 2002-107872.

Further, for continuously and stably producing the photothermographic material of the invention, a production method described in JP-A Nos. 2002-156728 or 2002-182333 is used preferably.

The photothermographic material is preferably a mono-sheet type (a type capable of forming images on a photothermographic material without using another sheet such as an image receiving material).

13) Packaging Material

The photosensitive material of the invention is preferably packaged by a packaging material with a low oxygen permeation rate and/or moisture permeation rate in order to prevent fluctuation of photographic performance during pre-use storage. Such a packaging material also reduces curling or crimping. The oxygen permeation rate at 25° C. is preferably 50 ml/atm/m²·day or less, more preferably 10 ml/atm/m²·day or less, and further preferably 1.0 ml/atm/m²·day or less. The moisture permeability is preferably 10 g/atm/m²·day or less, more preferably 5 g/atm/m²·day, and further preferably 1 g/atm/m²·day or less.

Specific examples of the packaging material with low oxygen permeability and/or moisture permeability are those materials described, for example, in the specification of JP-A Nos. 8-254793 and 2000-206653.

14) Other Applicable Techniques

Various techniques applicable to the photothermographic material of the invention include, for example, those described in, EP No. 803764A1, EP No. 883022A1, WO98/36322, JP-A Nos. 56-62648, 58-62644, 09-43766, 09-281637, 09-297367, 09-304869, 09-311405, 09-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, JP-A Nos. 2000-187298, 2000-10229, 2000-47345, 2000-206642, 2000-98530, 2000-98531, 2000-112059, 2000-112060, 2000-112104, 2000-112064, and 2000-171936.

Image-Forming Method

1) Exposure

He—Ne laser emitting red-infrared light, a red semiconductor laser or Ar⁺, He—Ne, He—Cd laser emitting blue-green light, and a blue semiconductor laser are used. The red-infrared semiconductor laser is preferably used. The peak wavelength of the laser light is 600 nm to 900 nm and, preferably, 620 nm to 850 nm. On the other hand, a module comprising an SHG (Second Harmonic Generator) device integrated with a semiconductor laser or a blue semiconductor laser has been developed in recent years, and a laser outputting device of a short wavelength region has been highlighted. Since the blue semiconductor laser may record images having high fineness, increase the recording density, has long life and further achieve a stable output, the demand therefor is expected to increase in the future. The peak wavelength of the blue laser light is preferably 300 nm to 500 nm, and particularly 400 nm to 500 nm.

It is preferred that the laser beam oscillates in a longitudinal multiple mode through, for example, high frequency wave superposition.

2) Heat Development

The photothermographic material of the invention may be developed by any method. Usually, the photothermographic material having imagewise exposed is developed by elevating the temperature. A preferred developing temperature is 80 to 250° C., more preferably 100 to 140° C. and further preferably 110 to 130° C. The developing time is usually 1 to 60 second in the image-forming method according to the present invention, and especially rapid development for 15 sec or less, and more preferably 7 to 15 sec is preferably conducted in the method of the present invention.

As the heat developing system, either a drum-type heater or a plate-type heater may be used, and the method using the plate-type heater is more preferred. Regarding the thermal development system using the plate-type heater, the method describe in JP-A No. 11-133572 is preferred. This method uses a thermal developing apparatus to create visible images by bringing the photothermographic material having formed latent images into contact with a heating member at a thermal developing portion. The heating device comprises a plate-type heater and a plurality of press rolls that are opposed along one surface of the plate-type heater. The photothermographic material is passed through the press rolls and the plate-type heater to conduct thermal development. It is preferred that the plate-type heater is divided into two to six stages and the temperature is lowered by about 1 to 10° C. for the tip end. For example, four sets of plate heaters each of which may be controlled in temperatures, for example, controlled to 112° C., 119° C., 121° C. and 120° C., respectively. Such a method as described in JP-A No. 54-30032 is useful in that a moisture or organic solvent present in the photothermographic material may be eliminated from the system. Further, deformation of the support for the photothermographic material by rapid heating of the photothermographic material can be suppressed.

In order to reduce the size of the heat developing machine and shorten the heat developing time, it is preferred if the heater may be controlled more stably. It is also desirable that light exposure is started from the leading part of one photosensitive material sheet and thermal development is started before completion of the light exposure as far as the trailing end. An imager that is capable of undergoing rapid processing for preferably use in the invention is described, for example, in Japanese Patent Application Nos. 2001-88832 and 2001-91114. By the use of the imager, a heat developing treatment may be applied, for example, in 14 sec by a three stage plate heaters controlled to 107° C.-121° C.-121° C. to thereby shorten the output time for the first sheet to about 60 sec. In this type of rapid developing treatment which had various problems as described above, the photothermographic material of the invention may preferably be used.

3) System

As a laser imager for medical use having an exposing portion and a thermal developing portion, Fuji Medical Dry Imager FM-DPL described in Fuji Medical Review No. 8, pages 39-55, and the techniques thereof may be utilized for the photothermographic material of the invention. Further, the photothermographic material according to the invention may also be applied for the laser imager in “AD network”, proposed by Fujifilm Medical Co., Ltd., a network system which fulfils the DICOM Standards.

Application of the Invention

The photothermographic material and the image-forming method according to the invention can form a monochromatic silver image, and hence may preferably be used in medical diagnosis, industrial photography, printing and COM (computer output microfilm). The photothermographic material and the image-forming method according to the invention are particularly preferably used in medical diagnosis.

### EXAMPLES

The present invention is described in more detail by way of examples given below. It should be noted that the invention is not limited to the following examples.

### Example 1

Preparation of PET Support

1) Film Formation

From terephthalic acid and ethylene glycol, PET was produced in an ordinary manner. PET thus produced had an intrinsic viscosity, IV, of 0.66, as measured in a phenol/tetrachloroethane ratio (6/4 by mass) at 25° C. After pelletized, the PET was dried at 130° C. for 4 hours, and melted at 300° C., followed by extrusion through a T-die. After rapid cooling, a non-oriented film was obtained which had a thickness of 175 μm after thermal fixation.

The resultant film was stretched 3.3 times in MD (machine direction) using a roll at different rotating speeds, then stretched 4.5 times in CD (cross direction) using a tenter. The temperatures for MD and CD stretchings were 110° C. and 130° C., respectively. Then, the film was thermally fixed at 240° C. for 20 seconds, and relaxed by 4% in CD at the same temperature. Subsequently, the chuck of the tenter was released, the both edges of the film was knurled, and the film was rolled up under 4 kg/cm² to give a rolled film having a thickness of 175 μm.

2) Corona Discharge Surface Treatment

Both surfaces of the support were subjected to corona discharge treatment at room temperature at a speed of 20 m/min, using a solid-state corona discharge system MODEL 6 KVA manufactured by Pillar Technologies. From the data of the current and the voltage read from the system, the support was found to be processed at 0.375 kV·A·min/m². The frequency for the treatment was 9.6 kHz, and the gap clearance between an electrode and a dielectric roll was 1.6 mm.

3) Undercoat

1) Preparation of Coating Solution for Undercoat Layer:
Formulation (1) (for an undercoat layer at the side of providing an
image-forming layer):

| | | |
|---|---|---|
| Pesuresin A-520 (a 30 mass % solution) manufactured by | 59 | g |
| Takamatsu Yushi KK | | |
| Polyethylene glycol monononylphenyl ether (average ethylene | 5.4 | g |
| oxide number = 8.5, a 10 mass % solution) | | |
| Polymer microparticles (MP-1000, mean particle size: | 0.91 | g |
| 0.4 μm) manufactured by Soken Chemical & | | |
| Engineering Co., Ltd. | | |
| Distilled water | 935 | ml |

Formulation (2) (for a first back layer):

| | | |
|---|---|---|
| Styrene-butadiene copolymer latex (solid content: 40 mass %, | 158 | g |
| styrene/butadiene ratio = 68/32 by mass) | | |
| Sodium 2,4-Dichloro-6-hydroxy-S-triazine (a 8 mass % | 20 | g |
| aqueous solution) | | |
| Sodium laurylbenzenesulfonate (a 1 mass % aqueous solution) | 10 | ml |
| Distilled water | 854 | ml |

Formulation (3) (for a second back layer):

| | | |
|---|---|---|
| SnO₂/SbO (9/1 by mass, mean particle size: 0.038 μm, | 84 | g |
| a 17 mass % dispersion) | | |
| Gelatin (a 10% aqueous solution) | 89.2 | g |
| Metolose TC-5 (a 2% aqueous solution) manufactured by | 8.6 | g |
| Shin-etsu Chemical Industry Co., Ltd. | | |
| MP-1000 manufactured by Soken Chemical & | 0.01 | g |
| Engineering Co., Ltd. | | |
| Sodium dodecylbenzenesulfonate (a 1 mass % aqueous | 10 | ml |
| solution) | | |
| NaOH (1 mass %) | 6 | ml |
| Proxel (manufactured by ICI) | 1 | ml |
| Distilled water | 805 | ml |

3) Undercoating

Both surfaces of the biaxially-oriented polyethylene terephthalate support (thickness: 175 μm) were subjected to corona discharge treatment in the same manner as above. One surface (to have an image-forming layer thereon) of the support was coated with a coating solution of the undercoat layer formulation (1) using a wire bar, and then dried at 180° C. for 5 minutes to provide a wet coated amount of 6.6 ml/m² (one surface). Next, the other surface (back surface) of the support was coated with a coating solution of the back layer formulation (2) using a wire bar, and then dried at 180° C. for 5 minutes to provide a wet coated amount of 5.7 ml/m². The thus-coated back surface was further coated with the back layer formulation (3) using a wire bar, and then dried at 180° C. for 6 minutes to provide a wet coated amount of 7.7 ml/m², to thereby give an undercoated support.

Back Layer

1) Preparation of Coating Solution for Back Layer

(Preparation of Fine Solid Particle Dispersion (a) of Base Precursor)

2.5 kg of a base precursor compound 1, 300 g of a surfactant (DEMOL N; trade name of products from Kao Co), 800 g of diphenylsulfone, 1.0 g of sodium benzothiazolinone and distilled water were added and mixed so as to be 8.0 kg in total, and a liquid mixture was put to beads dispersion by a horizontal sand mill (UVM-2; manufactured by IMEX Co.). The liquid mixture was fed by a diaphragm pump to UVM-2 filled with zirconia beads of an average diameter of 0.5 mm and dispersed until a desired average particle size was obtained in a state of an internal pressure at 50 hPa or higher.

The dispersion was dispersed until the ratio between absorption at 450 nm and absorption at 650 nm (D450/D650) in the spectral absorption of the dispersant reached 3.0 as a result of spectral absorptiometry. The obtained dispersion was diluted with distilled water such that the concentration of the base precursor was 25% by weight and filtered for removing dust (through a polyprolylene filter having an average pore size of 3 μm) for practical use.

2) Preparation of Fine Solid Dye Particle Dispersion

6.0 kg of a cyanine dye compound-1,3.0 kg of sodium p-dodecylbenzene sulfonate, 0.6 kg of a surfactant DEMOL SNB (manufactured by Kao Co.) and 0.15 kg of a defoamer (SURFINOL 104E, trade name of products manufactured by Nisshin Kagaku Co.) were mixed with distilled water to make up the total liquid amount to 60 kg. The liquid mixture was dispersed with zirconia beads of 0.5 mm using a horizontal sand mill (UVM-2: manufactured by IMEX Co.).

The dispersion was dispersed until the ratio between absorption at 650 nm and absorption at 750 nm (D650/D750) in the spectral absorption of the dispersant reached 5.0 or more as a result of spectral absorptiometry. The obtained dispersion was diluted with distilled water such that the concentration of the cyanine dye was 6% by mass and filtered for removing dust (average pore size: 1 μm) for practical use.

3) Preparation of Coating Solution for Anti-Halation Layer

The vessel was kept at 40° C., in which 40 g of gelatin, 20 g of monodispersed fine polymethyl methacrylate particles (average particle size 8 μm, particle size standard deviation 0.4), 0.1 g of benzoisothiazolinone and 490 ml of water were added to dissolve the gelatin. Further, 2.3 ml of an aqueous solution of 1 mol/L sodium hydroxide, 40 g of the fine solid dye particle liquid dispersion, 90 g of fine solid particle liquid dispersion of the base precursor (a), 12 ml of a 3% aqueous solution of sodium polystyrene sulfonate and 180 g of a 10% SBR latex solution were mixed. 80 ml of a 4% aqueous solution of N,N-ethylene bis(vinylsulfone acetoamide) was mixed therewith just before coating to prepare an anti-halation coating solution.

4) Preparation of Coating Solution for Back Surface Protective Layer

A vessel was kept at 40° C. in which 40 g of gelatin, 35 mg of benzoisothiazolinone and 840 ml of water were added to dissolve the gelatin. Further, 5.8 ml of an aqueous solution of 1 mol/L sodium hydroxide, 1.5 g of liquid paraffin emulsion as a liquid paraffin, 10 ml of a 5% aqueous solution of sodium di(2-ethylhexyl)sulfosuccinate, 20 ml of a 3% aqueous solution of sodium polystyrene sulfonate, 2.4 ml of 2% solution of fluorine-type surfactant (F-1), 2.4 ml of 2% solution of fluorine-type surfactant (F-2), and 32 g of 19% by mass solution of methyl methacrylate/styrene/butylacrylate/hydroxyethyl methacrylate/acrylic acid copolymer (copolymer weight ratio: 57/8/28/5/2) latex were mixed. Just before coating, 25 ml of a 4% aqueous solution of N,N-ethylene bis(vinylsulfone acetamide) was mixed to prepare a coating solution for a back surface protective layer.

4) Coating of Back Layer

On the back surface of the undercoated support, were coated an anti-halation layer coating solution such that the gelatin coating amount was 0.52 g/m² and a coating solution for protecting the back surface such that the gelatin coating amount was 1.7 g/m² by simultaneous multi-layer coating and then dried to prepare a back layer.

Image-Forming Layer, Intermediate Layer and Surface Protective Layer

1. Preparation of Coating Materials

1) Silver Halide Emulsion

Preparation of Silver Halide Emulsion 1:

To 1421 ml of distilled water were added 3.1 ml of a 1 mass % aqueous potassium bromide solution, followed by further addition of 3.5 ml of an aqueous sulfuric acid solution (5 mols/liter) and 31.7 g of phthalated gelatin. The resulting mixture was maintained at 30° C. with stirring in a stainless reactor, to which were added 95.4 ml of a solution A containing 22.22 g of silver nitrate diluted with distilled water, and 97.4 ml of a solution B containing 15.3 g of potassium bromide and 0.8 g of potassium iodide diluted with distilled water, at a fixed flow rate over a period of 45 seconds. Then, 10 ml of a 3.5 mass % aqueous hydrogen peroxide solution and then 10.8 ml of a 10 mass % aqueous benzimidazole solution were added thereto. To the resultant mixture were further added 317.5 ml of a solution C containing 51.86 g of silver nitrate diluted with distilled water at a fixed flow rate over a period of 20 minutes, and 400 ml of a solution D containing 44.2 g of potassium bromide and 2.2 g of potassium iodide diluted with distilled water employing a controlled double jet method while maintaining a constant pAg of 8.1. 10 minutes after the commencement of adding the solutions C and D, potassium hexachloroiridate(III) was added thereto to provide 1×10⁻⁴ mols per mol of silver. Five seconds after the completion of adding the solution C, an aqueous potassium ferrocyanide solution was added thereto to provide 3×10⁻⁴ mols per mol of silver. pH was controlled to be 3.8 with sulfuric acid (0.5 mols/liter). Stirring was halted, and the resultant mixture was precipitated, desalted and then washed with water. pH was controlled to be 5.9 with sodium hydroxide (1 mol/liter) to thus give a dispersion of silver halide having pAg of 8.0.

The produced dispersion of silver halide was maintained with stirring at 38° C., to which was added 5 ml of a solution of 0.34 mass % 1,2-benzoisothiazolin-3-one in methanol. 40 minutes after, the temperature was raised to 47° C. 20 minutes after raising, 7.6×10⁻⁵ mols, per mol of silver, of a solution of sodium benzenethiosulfonate in methanol was added; and 5 minutes after, 2.9×10⁻⁴ mols, per mol of silver, of a solution of tellurium sensitizer C in methanol was added, followed by ripening for 91 minutes. Then, a solution of spectral sensitizing dye A and spectral sensitizing dye B in a ratio of 3/1 by mol in methanol was added thereto to give a total amount of the spectral sensitizing dyes A and B of 1.2×10⁻³ mols per mol of silver and 1 minute after, 1.3 ml of a solution of 0.8 mass % N,N′-dihydroxy-N″-diethylmelamine in methanol was added thereto; and 4 minutes after, 4.8×10⁻³ mols, per mol of silver, of a solution of 5-methyl-2-mercaptobenzimidazole in methanol, 5.4×10⁻³ mols, per mol of silver, of 1-phenyl-2-heptyl-5-mercapto-1,3,4-triazole in methanol, and 8.5×10⁻³ mols, per mol of silver, of sodium 1-(3-methylureido)-5-mercaptotetrazole in methanol were added thereto, to finally prepare a silver halide emulsion 1.

The grains in the thus-prepared silver halide emulsion were silver iodobromide grains having a mean sphere-corresponding diameter of 0.042 μm and having a sphere-corresponding diameter fluctuation coefficient of 20%. The iodide content of the grains was 3.5 mol %, and the iodide was uniformly distributed within the grains. The grain size was obtained from 1,000 grains using an electronic microscope and taking an average. The {100} plane ratio of the grains was determined to be 80%, as measured according to the Kubelka-Munk method.

Preparation of Silver Halide Emulsion 2:

A silver halide emulsion 2 was produced in a similar manner to the procedures for preparing the silver halide emulsion 1, except that the liquid temperature for forming the grains was changed from 30° C. to 47° C.; the solution B was prepared by diluting 15.9 g of potassium bromide with distilled water to make a volume of 97.4 ml; the solution D was prepared by diluting 45.8 g of potassium bromide with distilled water to make a volume of 400 ml; the solution C was added over a period 30 minutes; and potassium ferrocyanide was not added. Further, similarly to the procedures for the silver halide emulsion 1, precipitating, desalting, washing with water and dispersing were conducted. In addition, similarly to the procedures for the silver halide emulsion 1, spectral sensitization and chemically sensitization were performed by adding 5-methyl-2-mercaptobenzimidazole and 1-phenyl-2-heptyl-5-mercapto-1,3,4-triazole, except that a solution of the spectral sensitizing dye A and the spectral sensitizing dye B (3/1 by mol) in methanol was added to give a total amount of the dyes A and B of 7.0×10⁻⁴ mols per mol of silver; the amount of the tellurium sensitizer C added was 1.1×10⁻⁴ mols per mol of silver; and the amount of 1-phenyl-2-heptyl-5-mercapto-1,3,4-triazole added was 3.3×10⁻³ mols per mol of silver, and the amount of 4.7×10⁻³ mols of sodium 1-(3-methylureido)-5-mercaptotetrazole, per mol of silver, to thus prepare a silver halide emulsion 2. The emulsion grains in the thus-prepared silver halide emulsion 2 were cubic, pure silver bromide grains having a mean sphere-corresponding diameter of 0.080 μm and having a sphere-corresponding diameter fluctuation coefficient of 20%.

Preparation of Silver Halide Emulsion 3:

A silver halide emulsion 3 was prepared in a similar manner to the procesures for preparing the silver halide emulsion 1, except that the liquid temperature for forming the grains was changed from 30° C. to 27° C. Also, similarly to the procedures for the silver halide emulsion 1, precipitating, desalting, washing with water and dispersing were conducted. In addition, similarly to the procedures for the silver halide emulsion 1, a dispersion of solids (an aqueous gelatin solution) of the spectral sensitizing dye A and the spectral sensitizing dye B (ratio: 1/1 by mol) was added to give a total amount of the spectral sensitizing dyes A and B of 6×10⁻³ mols per mol of silver; and the amount of the tellurium sensitizer C added was 5.2×10⁻⁴ mols per mol of silver, and adding 5×10⁻⁴ mols of bromoauric acid per mol of silver, and 2×10⁻³ mols of potassium thiocyanate per mol of silver, 3 minutes after the addition of a tellurium sensitizer. The emulsion grains in the thus-prepared silver halide emulsion 3 were silver iodobromide grains having a mean sphere-corresponding diameter of 0.034 μm and having a sphere-corresponding diameter fluctuation coefficient of 20%. The iodide content of the grains was 3.5 mol %, and the iodide was uniformly distributed within the grains.

Preparation of Mixed Emulsion A for Coating Solution:

70% by mass of the silver halide emulsion 1, 15% by mass of the silver halide emulsion 2 and 15% by mass of the silver halide emulsion 3 were dissolved, followed by addition of 7×10⁻³ mols, per mol of silver, of an aqueous solution of 1 mass % benzothiazolium iodide. Then, water was added thereto to make a mixed emulsion having a silver halide content of 38.2 g in terms of silver per kg of the mixed emulsion 1, followed by addition of sodium 1-(3-methylureido)-5-mercaptotetrazole to make 0.34 g thereof in terms of silver per kg of the mixed emulsion 1.

2) Preparation of Fatty Acid Silver Salt Dispersion

Preparation of Fatty Acid Silver Salt Dispersion A:

87.6 kg of benenic acid (EDENOR C22-85R manufactured by Henkel), 423 liters of distilled water, 49.2 liters of an aqueous NaOH solution (5 mols/liter), and 120 liters of tert-butanol were admixed together and allowed to cause reaction, with stirring at 75° C. for 1 hour, to prepare a solution of sodium behenate A. Separately, 206.2 liters of an aqueous solution (pH 4.0) of 40.4 kg of silver nitrate was prepared, and maintained at 10° C. 635 liters of distilled water and 30 liters of tert-butanol were poured into a reactor and maintained at 30° C., into which were fed, with stirring, the solution containing sodium behenate A prepared as above entirely and the aqueous silver nitrate solution prepared as above entirely at a predetermined flow rate, over a period of 93 minutes and 15 seconds, and 90 minutes, respectively. At this stage, for the duration of 11 minutes after the commencement of feeding the aqueous silver nitrate solution, only the aqueous silver nitrate solution could was added, then the sodium behenate solution A was started to be fed, and for the duration of 14 minutes and 15 seconds after completion of feeding the aqueous silver nitrate, only the sodium benenate solution A was added to the reactor. At this stage, the temperature inside the reactor was set at 30° C., and the temperature outside it was so controlled to keep the liquid temperature inside constant. The pipes through which the sodium behenate solution A flew was kept warm by steam tracing, and the steam opening was controlled to keep the liquid temperature at the outlet of the nozzle tip at 75° C. The pipes through which the aqueous silver nitrate solution flew was kept warm by circulating cold water outside the double-walled pipe. The positions at which the sodium behenate solution A and the aqueous silver nitrate solution, respectively, were added were disposed symmetrically to each other relative to the shaft of the stirrer, with the hights adjested in order not to contact with the reaction solution.

After addition of the sodium behenate solution A was completed, the reaction system was kept standing with stirring and the temperature maintained for 20 minutes, raised to 35° C. for 30 minutes, followed by ripening for 210 minutes. Subsequently, centrifugal filtration was conducted to separate solids, which were then washed with water until the conductivity of the filtrate water reached 35 μS/cm, to thus give a silver salt of the fatty acid as solids. The solids were stored as a wet cake without drying.

The silver behenate grains obtained as above were analyzed for the shape by electronmicroscopic photography, revealing that the obtained grains were flaky crystals having the dimensions of a=0.14 μm (thickness), b=0.4 μm (minor axis) and c=0.6 μm (major axis), all on average (a, b and c are determined as defined above). The mean aspect ratio was 5.2, the mean sphere-corresponding diameter was 0.52 μm and the mean sphere-corresponding fluctuation coefficient was 15%.

To the wet cake, corresponding to a weight of 260 kg in dry weight, were added 19.3 kg of polyvinyl alcohol (product name: PVA-217) and water to make a total weight of 1,000 kg, followed by forming it into a slurry using a dissolver blade and pre-dispersing in a pipeline-mixer (Type PM-10 manufactured by Mizuho Industries, Co.).

Next, the pre-dispersed stock solution was processed three times in a dispersion mixer (MICROFLUIDIZER M-610 manufactured by Microfluidex International Corporation, equipped with an interaction chamber, Type Z) at a controlled pressure of 1,260 kg/cm² to give a dispersion of silver behenate. Cooling was carried out by bellows-type heat exchangers disposed before and after an interaction chamber, with controlling the temperature of a coolant to achieve a dispersing temperature of 18° C.

Preparation of Fatty Acid Silver Salt Dispersion B:

(Preparation of Recrystallized Behenic Acid)

100 kg of behenic acid manufactured by Henkel Co. (trade name of product; Edenor C 22-85R) was mixed in 1,200 kg of isopropyl alcohol, dissolved at 50° C., filtered through a 10 μm filter, and then cooled to 30° C. to effect recrystallization. The cooling rate upon recrystallization was controlled to 3° C./hr. The resultant crystals were centrifugally filtered, scrubbed with 100 kg of isopropyl alcohol and then dried. When the obtained crystals were esterified and measured by GC-FID, behenic content was 96%, and, in addition, 2% of lignoceric acid, 2% of archidic acid and 0.001% of erucic acid were contained.

(Preparation of Fatty Acid Silver Salt Dispersion B)

88 kg of recrystallized behenic acid, 422 L of distilled water, 49.2 L of an aqueous NaOH solution at 5 mol/L concentration and 120 L of t-butyl alcohol were mixed and allowed to react while stirring at 75° C. for one hour to obtain a sodium behenate solution B. Separately, 206.2 L of an aqueous solution of 40.4 kg of silver nitrate (pH 4.0) was prepared and kept at a temperature of 10° C. A reaction vessel containing 635 L of distilled water and 30 L of t-butyl alcohol was kept at a temperature of 30° C. and a total amount of the sodium behenate solution B and a total amount of the aqueous solution of the silver nitrate were added with sufficient stirring at a constant flow rate for 93 min and 15 sec and 90 min, respectively.

In this case, only the aqueous solution of silver nitrate was added for 11 min after starting the addition of the aqueous solution of silver nitrate, addition of sodium behenate solution B was started subsequently, and only the sodium behenate solution B was added for 14 min and 15 sec after the end of the addition of the aqueous solution of silver nitrate. In this case, the temperature inside the reaction vessel was kept at 30° C. and the external temperature was controlled such that the liquid temperature was constant.

Further, pipelines for the addition system of the sodium behenate solution B were kept warm by circulating warm water to the outside of a double-walled pipe and controlled such that the liquid temperature at the exit of the addition nozzle tip was 75° C. Further, the temperature of the pipelines for the addition system of the aqueous solution of the silver nitrate was kept by circulating cold water to the outside of the double-walled pipe. The addition position for the sodium behenate solution B and the addition position for the aqueous solution of silver nitrate were arranged symmetrically with respect to the stirring axis as a center and adjusted to such a height as not in contact with the reaction solution.

After the completion of adding the sodium behenate solution B, it was stirred and left for 20 min at an initial temperature and then the temperature was elevated to 35° C. for 30 min and then ripening was conducted for 210 nm. Just after the completion of the ripening, solids were separated by centrifugal filtration and then washed with water such that the conductivity of the filtered water was 30 μS/cm. Thus, fatty acid silver salt was obtained. The obtained solids were stored as wet cakes without drying.

When the shape of the obtained silver behenate particles was evaluated by electron microscopic photography, they were crystals with a=0.21 μm, b=0.4 μm, c=0.4 μm in an average value, an average aspect ratio 2.1, and a fluctuation coefficient of an average sphere equivalent diameter of 11%. 19.3 kg of polyvinyl alcohol (trade name of products: PVA-217) and water were added to wet cakes corresponding to 260 kg of dry solids to make a total amount to 1,000 kg, which were then formed into a slurry by a dissolver blade and, further, preliminarily dispersed by a pipeline mixer (Model PM-10 manufactured by Mizuho Industry Co.).

Then, a stock solution after the preliminary dispersion was treated three times while controlling the pressure of a dispersing machine (trade name; Micro Fluidizer M-610, manufactured by MicroFluidex International Corp., using Z-type interaction chamber) to 1150 kg/cm², to obtain a silver behenate dispersion. For the cooling operation, bellows-type heat exchangers were mounted before and after the interaction chamber, respectively, and the dispersion temperature was set at 18° C. by controlling the temperature of a coolant.

(Preparation of Fatty Acid Silver Salt Dispersion C)

44 kg of recrystallized behenic acid, 211 L of distilled water, 24.6 L of an aqueous NaOH solution at 5 mol/L concentration and 60 L of t-butyl alcohol were mixed and allowed to react while stirring at 75° C. for one hour to obtain a sodium behenate solution C1. 36.8 kg of stearic acid (purity: 99.9%), 211 L of distilled water, 24.6 L of an aqueous NaOH solution at 5 mol/L concentration and 60 L of t-butyl alcohol were mixed and allowed to react while stirring at 75° C. for one hour to obtain a sodium stearate solution C2. Separately, 206.2 L of an aqueous solution of 40.4 kg of silver nitrate (pH 4.0) was prepared and kept at a temperature of 10° C. A reaction vessel containing 635 L of distilled water and 30 L of t-butyl alcohol was kept at a temperature of 30° C. and a total amount of the sodium behenate solution C1 and a total amount of the aqueous solution of the silver nitrate were added with sufficient stirring at a constant flow rate for 46 min and 38 sec and 90 min, respectively.

In this case, only the aqueous solution of silver nitrate was added for 11 min after starting the addition of the aqueous solution of silver nitrate, addition of sodium behenate solution C1 was started subsequently a sodium stearate solution was added simultaneously with completion of addition, and only the sodium stearate solution C2 was added for 14 min and 15 sec after the end of the addition of the aqueous solution of silver nitrate. In this case, the temperature inside the reaction vessel was kept at 30° C. and the external temperature was controlled such that the liquid temperature was constant. Further, pipelines for the addition system of the sodium behenate solution C1 and the sodium stearate solution C2 were kept warm by circulating warm water to the outside of a double-walled pipe and controlled such that the liquid temperature at the exit of the addition nozzle tip was 75° C. Further, the temperature of the pipelines for the addition system of the aqueous solution of the silver nitrate was kept by circulating cold water to the outside of the double-walled pipe. The addition position for the sodium behenate solution C1 and the sodium stearate solution C2 and the addition position for the aqueous solution of silver nitrate were arranged symmetrically with respect to the stirring axis as a center and adjusted to such a height as not in contact with the reaction solution.

After the completion of adding the sodium stearate solution C2, it was stirred and left for 20 min at the temperature as it was and then the temperature was elevated to 35° C. for 30 min and then ripening was conducted for 210 min. Just after the completion of the ripening, solid contents were separated by centrifugal filtration and the solids were water-washed such that the conductivity of the filtered water was 30 μS/cm. Thus, fatty acid silver salt was obtained. The obtained solids were stored as wet cakes without drying.

When the shape of the obtained fatty acid silver salt particles was evaluated by electron microscopic photography, they were crystals with a=0.11 μm, b=0.2 μm, c=0.2 μm in an average value, an average aspect ratio 2.1, and a fluctuation coefficient of an average sphere equivalent diameter of 14%.

19.3 kg of polyvinyl alcohol (trade name of products: PVA-217) and water were added to wet cakes corresponding to 260 kg of dry solids to make a total amount to 1,000 kg, which were then formed into a slurry by dissolver blades and, further, preliminarily dispersed by a pipeline mixer (Model PM-10, manufactured by Mizuho Industry Co.).

Then, a stock solution after the preliminary dispersion was treated three times while controlling the pressure of a dispersing machine (trade name; Micro Fluidizer M-610, manufactured by MicroFluidex International Corp., using Z-type interaction chamber) to 1150 kg/cm², to obtain a silver behenate dispersion. For the cooling operation, bellows-type heat exchangers were mounted before and after the interaction chamber, respectively, and the dispersion temperature was set at 18° C. by controlling the temperature of a coolant.

(Preparation of Fatty Acid Silver Salt Dispersion D)

22 kg of recrystallized behenic acid, 105.5 L of distilled water, 12.3 L of an aqueous NaOH solution at 5 mol/L concentration and 30 L of t-butyl alcohol were mixed and allowed to react while stirring at 75° C. for one hour to thereby obtain a sodium behenate solution D1. 55.2 kg of stearic acid (99.9% purity), 316.5 L of distilled water, 36.9 L of an aqueous NaOH solution at 5 mol/L concentration and 90 L of t-butyl alcohol were mixed and allowed to react while stirring for one hour at 75° C. to obtain a sodium stearate solution D2. Separately, 206.2 L of an aqueous solution of 40.4 kg of silver nitrate (pH 4.0) was prepared and kept at a temperature of 10° C. A reaction vessel containing 635 L of distilled water and 30 L of t-butyl alcohol was kept at a temperature of 30° C. and a total amount of the sodium behenate solution C1 and a total amount of the aqueous solution of the silver nitrate were added with sufficient stirring at a constant flow rate for 23 min and 19 sec and 90 min, respectively. In this case, only the aqueous solution of silver nitrate was added for 11 min after starting the addition of the aqueous solution of silver nitrate, addition of sodium behenate solution D1 was started subsequently a sodium stearate solution was added simultaneously with the completion of addition, and only the sodium stearate solution D2 was added for 14 min and 15 sec after the end of the addition of the aqueous solution of silver nitrate. In this case, the temperature inside the reaction vessel was kept at 30° C. and the external temperature was controlled such that the liquid temperature was constant. Further, pipelines for the addition system of the sodium behenate solution D1 and the sodium stearate solution D2 were kept warm by circulating warm water to the outside of a double-walled pipe and controlled such that the liquid temperature at the exit of the addition nozzle tip was 75° C. Further, the temperature of the pipelines for the addition system of the aqueous solution of the silver nitrate was kept by circulating cold water to the outside of the double-walled pipe. The addition position for the sodium behenate solution D 1 and the sodium stearate solution D2, and the addition position for the aqueous solution of silver nitrate were arranged symmetrically with respect to the stirring axis as a center and adjusted to such a height as not in contact with the reaction solution.

After the completion of adding the sodium stearate solution D2, it was stirred and left for 20 min at an initial temperature and then the temperature was elevated to 35° C. for 30 min and then ripening was conducted for 210 min. Just after the completion of the ripening, solid contents were separated by centrifugal filtration and the solids were water-washed such that the conductivity of the filtered water was 30 μS/cm. Thus, fatty acid silver salt was obtained. The obtained solids were stored as wet cakes without drying.

When the form of the obtained fatty acid silver salt particles was evaluated by electron microscopic photography, they were flaky crystals with a=0.11 μm, b=0.15 μm, c=0.16 μm in an average value and an average aspect ratio of 1.8 and a fluctuation coefficient of an average sphere equivalent diameter of 13%.

19.3 kg of polyvinyl alcohol (trade name of products: PVA-217) and water were added to wet cakes corresponding to 260 kg of dry solids to make a total amount to 1,000 kg, which were then formed into a slurry by dissolver blades and, further, preliminarily dispersed by a pipeline mixer (Model PM-10, manufactured by Mizuho Industry Co.).

Then, a stock solution after the preliminary dispersion was treated three times while controlling the pressure of a dispersing machine (trade name; Micro Fluidizer M-610, manufactured by MicroFluidex International Corp., using Z-type interaction chamber) to 1150 kg/cm², to obtain a silver behenate dispersion. For the cooling operation, bellows-type heat exchangers were mounted before and after the interaction chamber, respectively, and the dispersion temperature was set at 18° C. by controlling the temperature of a coolant.

(Preparation of Fatty Acid Silver Salt Dispersion E)

66 kg of re-crystallized behenic acid, 316.5 L of distilled water, 36.9 L of an aqueous NaOH solution at 5 mol/L concentration and 90 L of t-butyl alcohol were mixed and allowed to react while stirring at 75° C. for one hour to obtain a sodium behenate solution E1. 18.4 kg of stearic acid (purity 99.9%), 105.5 L of distilled water, 12.3 L of an aqueous NaOH solution at 5 mol/L concentration and 30 L of t-butyl alcohol were mixed, stirred and allowed to react at 75° C. for one hour to obtain a sodium stearate solution E2. Separately, 206.2 L of an aqueous solution of 40.4 kg of silver nitrate (pH 4.0) was prepared and kept at a temperature of 10° C. A reaction vessel containing 635 L of distilled water and 30 L of t-butyl alcohol was kept at a temperature of 30° C. and a total amount of the sodium behenate solution E1 and a total amount of the aqueous solution of the silver nitrate were added with sufficient stirring at a constant flow rate for 69 min and 57 sec and 90 min, respectively.

In this case, only the aqueous solution of silver nitrate was added for 11 min after starting the addition of the aqueous solution of silver nitrate, addition of sodium behenate solution E1 was started subsequently a sodium stearate solution was added simultaneously with completion of addition, and only the sodium stearate solution E2 was added for 14 min and 15 sec after the end of the addition of the aqueous solution of silver nitrate. In this case, the temperature inside the reaction vessel was kept at 30° C. and the external temperature was controlled such that the liquid temperature was constant.

Further, pipelines for the addition system of the sodium behenate solution E1 and the sodium stearate solution E2 were kept warm by circulating warm water to the outside of a double-walled pipe and controlled such that the liquid temperature at the exit of the addition nozzle tip was 75° C. Further, the temperature of the pipelines for the addition system of the aqueous solution of the silver nitrate was kept by circulating cold water to the outside of the double-walled pipe. The addition position for the sodium behenate solution E1 and the sodium stearate solution E2 and the addition position for the aqueous solution of silver nitrate were arranged symmetrically with respect to the stirring axis as a center and adjusted to such a height as not in contact with the reaction solution.

After the completion of adding the sodium stearate solution E2, it was stirred and left for 20 min at an initial temperature and then the temperature was elevated to 35° C. for 30 min and then ripening was conducted for 210 nm. Just after the completion of the ripening, solids were separated by centrifugal filtration and the solids were washed with water such that the conductivity of the filtered water was 30 μS/cm. Thus, fatty acid silver salt was obtained. The obtained solids were stored as wet cakes without drying.

When the shape of the obtained fatty acid silver salt particles was evaluated by electron microscopic photography, they were crystals, with a=0.14 μm, b=0.22 μm, c=0.24 μm in an average value, an average aspect ratio of 1.8 and a fluctuation coefficient of an average sphere equivalent diameter of 14%.

19.3 kg of polyvinyl alcohol (trade name of products: PVA-217) and water were added to wet cakes corresponding to 260 kg of dry solids to make a total amount of 1,000 kg, which were then formed into a slurry by dissolver blades and, further, preliminarily dispersed by a pipeline mixer (Model PM-10, manufactured by Mizuho Industry Co.).

Then, a stock solution after the preliminary dispersion was treated three times while controlling the pressure of a dispersing machine (trade name; Micro Fluidizer M-610, manufactured by MicroFluidex International Corp., using Z-type interaction chamber) to 1150 kg/cm², to obtain silver behenate dispersion. For the cooling operation, bellows-type heat exchangers were mounted before and after the interaction chamber, respectively, and the dispersion temperature was set at 18° C. by controlling the temperature of a coolant.

3) Preparation of Reducing Agent Dispersion

(Preparation of Reducing Agent-1 Dispersion)

10 kg of water was added to 10 kg of a reducing agent-1 (2,2′-methylenebis-(4-ethyl-6-tert-butylphenol) and 16 kg of a 10% by mass aqueous solution of a modified polyvinyl alcohol (Poval MP203, manufactured by Kuraray Co.) and mixed thoroughly to prepare a slurry. The slurry was fed by a diaphragm pump and, after dispersion by a horizontal type sand mill filled with zirconia beads with an average diameter of 0.5 mm (UVM-2: manufactured by IMEX Co.) for 3 hours, 0.2 g of sodium salt of benzoisothiazolinone and water were added to prepare such that the concentration of the reducing agent was 25% by mass. The liquid dispersion was heated at 60° C. for 5 hours, to obtain a reducing agent-1 dispersion. The thus obtained reducing agent particles contained in the reducing agent dispersion had a median diameter of 0.40 μm and a maximum particle diameter of 1.4 μm or less. The obtained reducing agent dispersion was filtered through a polypropylene filter having a pore size of 3.0 μm to remove foreign matters such as dust and stored.

(Preparation of Reducing Agent-2 Dispersion)

10 kg of water was added to 10 kg of a reducing agent-1 (6,6′-di-t-butyl-4,4′-dimethyl-2,2′-butylidenediphenol) and 16 kg of a 10% by mass aqueous solution of a modified polyvinyl alcohol (Poval MP203, manufactured by Kuraray Co.) and mixed thoroughly to prepare a slurry. The slurry was fed by a diaphragm pump and, after dispersion by a horizontal type sand mill filled with zirconia beads with an average diameter of 0.5 mm (UVM-2: manufactured by IMEX Co.) for 3 hours and 30 min. Then, 0.2 g of sodium salt of benzoisothiazolinone and water were added to prepare such that the concentration of the reducing agent was 25% by mass. The liquid dispersion was heated at 40° C. for one hour and then successively applied with a heat treatment at 80° C. for one hour, to obtain a reducing agent-2 dispersion. The thus obtained reducing agent particles contained in the reducing agent dispersion had a median diameter of 0.50 μm and a maximum particle diameter of 1.6 μm or less. The obtained reducing agent dispersion was filtered through a polypropylene filter having a pore size of 3.0 μm to remove foreign matters such as dust and stored.

4) Preparation of Hydrogen Bond-Forming Compound-1 Dispersion

10 kg of water was added to 10 kg of a hydrogen bond-forming compound-1 (tri(4-t-butylphenyl)phosphin oxide) and 16 kg of a 10% by mass aqueous solution of a modified polyvinyl alcohol (Poval MP203, manufactured by Kuraray Co.) and mixed thoroughly to prepare a slurry. The slurry was fed by a diaphragm pump and, after dispersion by a horizontal type sand mill filled with zirconia beads with an average diameter of 0.5 mm (UVM-2: manufactured by IMEX Co.) for 4 hours, 0.2 g of sodium benzoisothiazolinone and water were added to prepare such that the concentration of the hydrogen bond-forming compound was 25% by mass. The liquid dispersion was heated at 40° C. for one hour and then heat treated at 80° C. for one hour, to obtain a hydrogen bond-forming compound-1 dispersion. The thus obtained hydrogen bond-forming compound particles contained in the hydrogen bond-forming compound dispersion had a median diameter of 0.45 μm and a maximum particle diameter of 1.3 μm or less. The obtained hydrogen bond-forming compound dispersion was filtered through a polypropylene filter having a pore size of 3.0 μm to remove foreign matters such as dust and stored.

5) Preparation of Development Accelerator-1 Dispersion

10 kg of water was added to 10 kg of a development accelerator-1 and 20 kg of a 10% by mass aqueous solution of a modified polyvinyl alcohol (Poval MP203, manufactured by Kuraray Co.) and mixed thoroughly to prepare a slurry. The slurry was fed by a diaphragm pump and, after dispersion by a horizontal type sand mill filled with zirconia beads with an average diameter of 0.5 mm (UVM-2: manufactured by IMEX Co.) for 3 hours and 30 min, 0.2 g of sodium benzoisothiazolinone and water were added to prepare such that the concentration of the development accelerator as 20% by mass, to obtain a development accelerator-1 dispersion. The thus obtained development accelerator particles in the development accelerator dispersion had a median size of 0.48 μm and a maximum particle size of 1.4 μm or less. The obtained dispersion was filtered through a polypropylene filter having a pore size of 3.0 μm to remove foreign matters such as dust and stored.

Solid dispersions of the development accelerator-2 and toning agent-1 were also dispersed by the same method as in the development accelerator-1, to obtain liquid dispersion of 20% by mass and 15% by mass, respectively.

6) Preparation of Polyhalogen Compound Dispersion

(Preparation of Organic Polyhalogen Compound-1 Dispersion)

10 kg of an organic polyhalogen compound-1 (tribromo methanesulfonyl benzene), 10 kg of a 20% by mass aqueous solution of modified polyvinyl alcohol (Poval MP203, manufactured by Kuraray Co.), 0.4 kg of a 20% by mass aqueous solution of sodium triisopropyl naphthalene sulfonate and 14 kg of water were added and mixed thoroughly to form a slurry. The slurry was fed by a diaphragm pump and dispersed in a horizontal type sand mill filled with zirconia beads of an average diameter of 0.5 mm (UVM-2: manufactured by IMEX Co.) for 5 hours and then 0.2 g of sodium salt of benzoisothiazolinone and water were added to prepare such that concentration of the organic polyhalogen compound was 26% by mass, to obtain an organic polyhalogen compound-1 dispersion. The thus obtained organic polyhalogen compound particles contained in the organic trihalogen compound dispersion had a median diameter and of 0.41 μm and a maximum particle size of 2.0 μm or less. The obtained organic polyhalogen compound dispersion was filtered through a polypropylene filter having a pore size of 10.0 μm to remove foreign matters such as dust and stored.

(Preparation of Organic Polyhalogen Compound-2 Dispersion)

10 kg of an organic polyhalogen compound-2 (N-butyl-3-tribromo methane sulfonuyl benzoamide), 20 kg of a 20% by mass aqueous solution of modified polyvinyl alcohol (Poval MP203, manufactured by Kuraray Co.) and 0.4 kg of a 20% by mass aqueous solution of sodium triisopropyl naphthalene sulfonate were added and mixed thoroughly to form a slurry. The slurry was fed by a diaphragm pump and dispersed in a horizontal type sand mill filled with zirconia beads of an average diameter of 0.5 mm (UVM-2: manufactured by IMEX Co.) for 5 hours and then 0.2 g of sodium benzoisothiazolinone and water were added to prepare such that concentration of the organic polyhalogen compound was 30% by mass. The dispersion was heated at 40° C. for 5 hours to obtain a polyhalogen compound-2 dispersion. The thus obtained organic polyhalogen compound particles contained in the organic polyhalogen compound-2 dispersion had a median diameter of 40 μm and a maximum particle size of 1.3 μm or less. The obtained organic polyhalogen compound dispersion was filtered through a polypropylene filter having a pore size of 3.0 μm to remove foreign matters such as dust and stored.

7) Preparation of Phthalazine Compound-1 Solution

8 kg of modified polyvinyl alcohol MP 203 (manufactured by Kuraray Co.) was dissolved in 174.57 kg of water and then 3.15 kg of a 20% by mass aqueous solution of sodium triisopropyl naphthalene sulfonate and 14.28 kg of a 70% by mass aqueous solution of phthalazine compound-1 (6-isopropyl phthalazine) were added to prepare a 5% by mass solution of phthalazine compound-1.

8) Preparation of Mercapto Compound

(Preparation of Aqueous Mercapto Compound-1 Solution)

7 g of a mercapto compound-1 (sodium 1-(3-sulfophenyl)-5-mercaptotetrazole) was dissolved in 993 g of water to form a 0.7% by mass aqueous solution.

Preparation of Aqueous Mercapto Compound-2 Solution:

20 g of a mercapto compound-2 (sodium 1-(3-methylureido)-5-mercaptotetrazole) was dissolved in 980 g of water to form a 2.0% by mass aqueous solution.

9) Preparation of Pigment-1 Dispersion

250 g of water was added to 64 g of C.I. Pigment Blue 60 and 6.4 g of DEMOL N (manufactured by Kao Corp.) and mixed thoroughly to form a slurry. 800 g of zirconia beads having an average diameter of 0.5 mm was prepared and charged, together with the slurry, into a vessel and after dispersing operation in a dispersing device (¼ G sand grinder mill, manufactured by IMEX Co.) for 25 hours, water was added thereto such that the pigment concentration was 5% by mass to thereby obtain a pigment-1 dispersion. The average particle size of the pigment particles contained in the obtained pigment dispersion was 0.21 μm.

10) Preparation of SBR Latex Solution

An SBR latex was prepared as described below.

287 g of distilled water, 7.73 g of a surfactant (Pionin A-43-S (manufactured by Takemoto Yushi Co.): solid content, 48.5%), 14.06 ml of 1 mol/L NaOH, 0.15 g of tetrasodium ethylenediamine tetraacetate, 255 g of styrene, 11.25 g of acrylic acid and 3.0 g of tert-dodecylmercaptane were charged into a polymerization vessel of a gas monomer reaction device (model TAS-2J, manufactured by Taiatsu Glass Industry Co.), the reaction vessel was tightly sealed and stirring was provided at a speed of 200 rpm. After evacuating through a vacuum pump and a nitrogen gas substitution repeated several times, 108.75 g of 1,3-butadiene was charged under pressure and the temperature was elevated to an internal temperature of 60° C. A solution containing 1.875 g of ammonium persulfate dissolved in 50 ml of water was added and stirred for 5 hours as it was. Further, stirring was conducted for three hours with raising the temperature to 90° C., and after the completion of the reaction and after lowering the internal temperature to room temperature, NaOH and NH₄OH at 1 mol/L were added such that Na⁺ ion: NH₄⁺ ion=1:5.3 (molar ratio) to adjust a pH to 8.4. Then, filtration was conducted through a polypropylene filter having a pore size of 1.0 μm to remove foreign matters such as dust and stored to obtain 774.7 g of an SBR latex. When halogen ions were measured by ion chromatography, a chloride concentration was 3 ppm. The concentration of a chelating agent by high-speed liquid chromatography was measured and found to be 145 ppm.

The latex had an average particle size of 90 nm, Tg=17° C., a solid content of 44% by mass, an equilibrium water content of 0.6% by mass at 25° C., 60% RH, an ionic conductivity 4.80 mS/cm (ionic conductivity was measured using a conductivity meter CM-30S manufactured by To a Denpa Industry Co. for latex stock solution (44% by mass) at 25° C.).

2. Preparation of Coating Solution

1) Preparation of Image-forming Layer Coating Solutions 1-5

1,000 g of each fatty acid silver salt dispersion A-E obtained as described above, 135 ml of water, 35 g of pigment-1 dispersion, 19 g of organic polyhalogen compound-1 dispersion, 58 g of organic polyhalogen compound-2 dispersion, 162 g of phthalazine compound-1 solution, 1,060 g of SBR latex (Tg: 17° C.) solution, 75 g of reducing agent-1, 75 g of reducing agent-2 dispersion, 106 g of hydrogen bond-forming compound-1 dispersion, 4.8 g of development accelerator-1 dispersion, 9 mol of an aqueous solution of mercapto compound-1, and 27 ml of an aqueous solution of mercapto compound-2 were added successively, and 118 g of a silver halide emulsion mixture A was added just before coating of 10 g urea and mixed thoroughly to form image-forming layer coating solutions 1-5, which were fed as they were to a coating dye.

The content of zirconia in the coating solution was 0.32 mg per g of silver.

2) Preparation of Image-Forming Layer Coating Solutions 6-10

1,000 g of each fatty acid silver salt dispersion A-E obtained as described above, 135 ml of water, 36 g of pigment-1 dispersion, 25 g of organic polyhalogen compound-1 dispersion, 39 g of organic polyhalogen compound-2 dispersion, 171 g of phthalazine compound-1 solution, 1,060 g of SBR latex (Tg: 17° C.) solution, 153 g of reducing agent-2 dispersion, 55 g of hydrogen bond-forming compound-1 dispersion, 4.8 g of development accelerator-1 dispersion, 5.2 g of development accelerator-2 dispersion, 2.1 g of toning agent-1 dispersion, 8 ml of an aqueous solution of mercapto compound-2 were added successively, and 140 g of a silver halide emulsion mixture A was added just before coating of 10 g urea and mixed thoroughly to form image-forming layer coating solutions 6-10, which were fed as they were to a coating dye.

The content of zirconia in the coating solution was 0.30 mg per g of silver.

3) Preparation of Intermediate Layer Coating Solution

27 ml of a 5% by mass aqueous solution of aerosol OT (manufactured by American Cyanamid Co.) and 14.2 ml of a 10% by mass aqueous solution of sodium chloride were added to 1,000 g of polyvinyl alcohol PVA-205 (manufactured by Kuraray Co.), 163 g of pigment-1 dispersion, 33 g of an aqueous solution of blue dye compound-1 (KAYAFECT turquoise RN liquid 150, manufactured by Nippon Kayaku Co.), 27 ml of 5% aqueous solution of sodium di(2-ethylhexyl) sulfosuccinate, and 4,200 ml 19% by mass solution of methylmethacrylate/styrene/butyl acrylate/hydroxyethyl methacrylate/acrylic acid copolymer (copolymerization weight ratio 57/8/28/5/2) latex, and water was added thereto such that a total amount was 10,000 g, which was controlled to pH 7.5 with NaOH to form an intermediate layer coating solution and fed to a coating die at 8.9 ml/m².

The viscosity of the coating solution was 58 mPa·S when measured by a B-type viscometer at 40° C. (No. 1 rotor, 60 rpm).

4) Preparation of Coating Solution for Surface Protective First Layer

100 g of inert gelatin and 10 mg of benzoisothiazolinone were dissolved in 840 ml of water, and 180 g of a 19% by mass solution of methyl methacrylate/styrene/butyl acrylate/hydroxyethyl methacrylate/acrylic acid copolymer (copolymerization weight ratio 57/8/28/5/2) latex, 46 ml of a 15% by mass methanol solution of phthalic acid, 5.4 ml of a 5% by mass aqueous solution of sodium di(2-ethylhexyl) sulfosuccinate were added and mixed, and 40 ml of a 4% by mass chrome alum was mixed just before coating by a static mixer, which was fed to a coating dye at a coating solution amount of 26.1 ml/m².

The viscosity of the coating solution was 20 mPa·S when measured by a B-type viscometer at 40° C. (No. 1 rotor, 60 rpm).

5) Preparation of Coating Solution for Surface Protective Second Layer

100 g of inert gelatin and 10 mg of benzoisothazolinone were dissolved in 800 ml of water, and 180 g of a 19% by mass solution of methyl methacrylate/styrene/butyl acrylate/hydroxyethyl methacrylate/acrylic acid copolymer (copolymerization weight ratio 57/8/28/5/2) latex, 40 ml of a 15% by mass solution of phthalic acid, 5.5 ml of a 1% by mass solution of a fluorine-type surfactant (F-1), 5.5 ml of a 1% by mass aqueous solution of a fluorine-type surfactant (F-2), 28 ml of a 5% by mass aqueous solution of sodium di(2-ethylhexyl)sulfosuccinate, 4 g of fine polymethyl methacrylate particles (average particle size of 0.7 μm), 21 g of polymethyl methacrylate particles (average particle size of 4.5 μm) were mixed as a surface protective layer coating solution, which was fed to a coating dye at 8.3 ml/m².

The viscosity of the coating solution was 19 mPa·S when measured by a B-type viscometer at 40° C. (No. 1 rotor, 60 rpm).

3. Preparation of Photothermographic Materials 1-10

1) Preparation of Photothermographic Materials 1-5

On the back side of the undercoated support were applied an anti-halation layer coating solution having a gelatin coating amount of 0.52 g/m² and a back surface protective layer coating solution at a gelatin coating amount of 1.7 g/m² by simultaneous multi-layer coating, and then dried to prepare a back layer.

An image-forming layer, an intermediate layer, a surface protection first layer and a surface protective second layer were provided in this order on an undercoat layer, on the surface opposite to the back surface, by simultaneous multi-layer coating through a slide bead coating method to thereby prepare a sample of a photothermographic material. The temperature was controlled at 31° C. for the image-forming layer and the intermediate layer, at 36° C. for the surface protective first layer and at 37° C. for the surface protective second layer, respectively.

The coating amounts (g/m²) of the respective compounds in the image-forming layer are described below. The addition amount of the fatty acid silver salt is an addition amount of the fatty acid silver salt corresponding to the total amount of the fatty acids used, based on a unit of mol/m².

| | |
|---|---|
| Fatty acid silver salt | (0.0121) |
| Pigment (C. I. Pigment Blue 60) | 0.036 |
| Polyhalogen compound-1 | 0.12 |
| Polyhalogen compound-2 | 0.25 |
| Phthalazine compound-1 | 0.18 |
| SBR latex | 9.70 |
| Reducing agent-1 | 0.40 |
| Reducing agent-2 | 0.40 |
| Hydrogen bond-forming compound-1 | 0.58 |
| Development accelerator-1 | 0.02 |
| Mercapto compound-1 | 0.002 |
| Mercapto compound-2 | 0.012 |
| Urea | 0.05 |
| Silver halide (in terms of Ag) | 0.10 |

Coating and drying conditions are as shown below.

Coating was conducted at a speed of 160 m/min, the gap between the coating die top end and the support was controlled to 0.10 to 0.30 mm, and the pressure in a reduced pressure chamber was set lower by 196 to 882 Pa than the atmospheric pressure. The support was destaticized with an ionized air before coating.

In a subsequent chilling zone, the coating solution was cooled by blowing at a dry bulb temperature of 10 to 20° C. and then it was conveyed in a non-contact manner, and dried in a helical non-contact type drying apparatus with a drying air at a dry bulb temperature of 23-45° C. and at a wet bulb temperature of 15 to 21° C.

After drying and controlling the humidity to 40 to 60% RH at 25° C., the film surface was heated to 70-90° C. After heating, the film surface was cooled to 25° C.

The matte degree of the thus prepared photothermographic material according to Beck's smoothness was 550 sec on the side of the photosensitive layer and 130 sec on the back surface. Further, a pH at the film surface on the side of the photosensitive layer was measured and found to be 6.0.

2) Preparation of Photothermographic Materials 6-10

Photothermographic materials 6-10 were prepared in the same manner as for the Photothermographic materials 1-5, except that the image-forming layer coating solutions 1-5 were changed to image-forming layer coating solutions 6-10.

The coating amounts (g/m²) of the respective compounds in the image-forming layer are described below. The addition amount of the fatty acid silver salt is an addition amount of the fatty acid silver salt corresponding to the total amount of the fatty acids used, based on a unit of mol/m².

| | |
|---|---|
| Fatty acid silver salt | (0.01176) |
| Pigment (C. I. Pigment Blue 60) | 0.036 |
| Polyhalogen compound-1 | 0.14 |
| Polyhalogen compound-2 | 0.28 |
| Phthalazine compound-1 | 0.18 |
| SBR latex | 9.43 |
| Reducing agent-2 | 0.77 |
| Hydrogen bond-forming compound-1 | 0.28 |
| Development accelerator-1 | 0.019 |
| Development accelerator-2 | 0.016 |
| Toning agent-1 | 0.006 |
| Mercapto compound-2 | 0.003 |
| Urea | 0.049 |
| Silver halide (in terms of Ag) | 0.13 |

Chemical structures of the compounds used in Examples of the present invention are shown below. 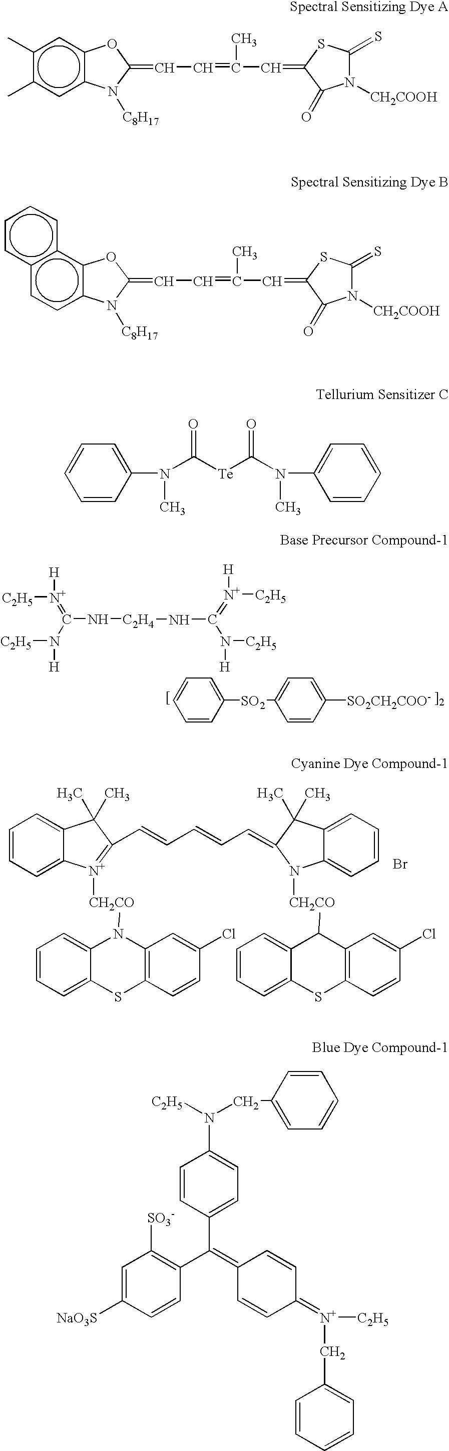 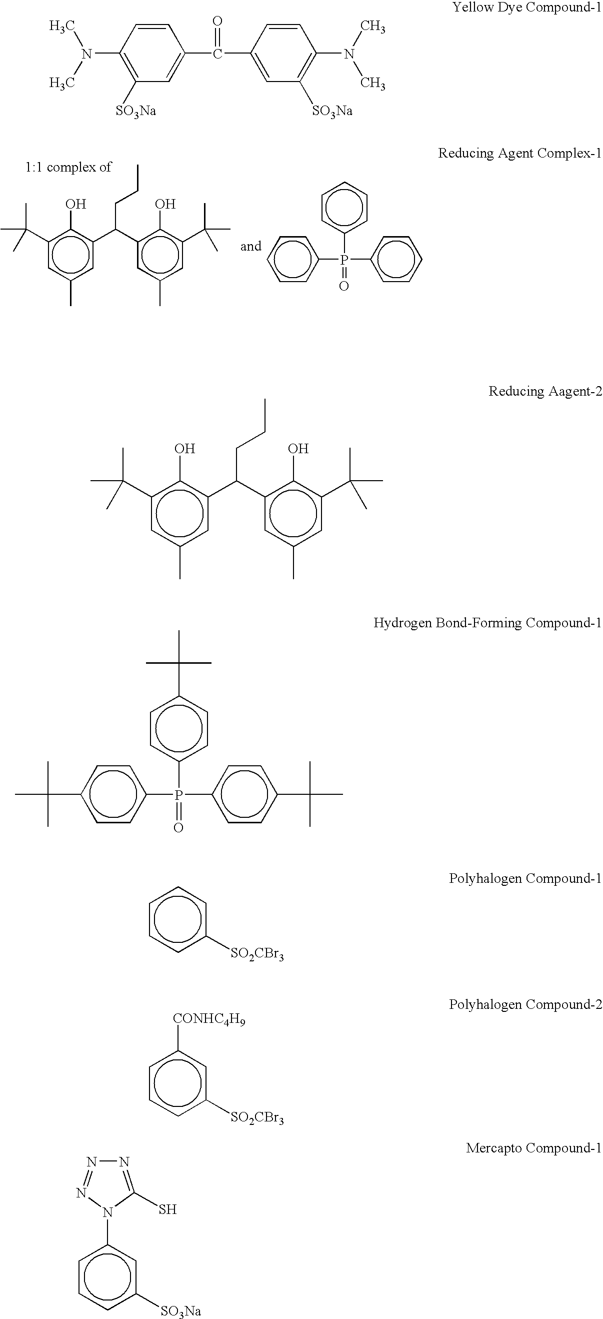 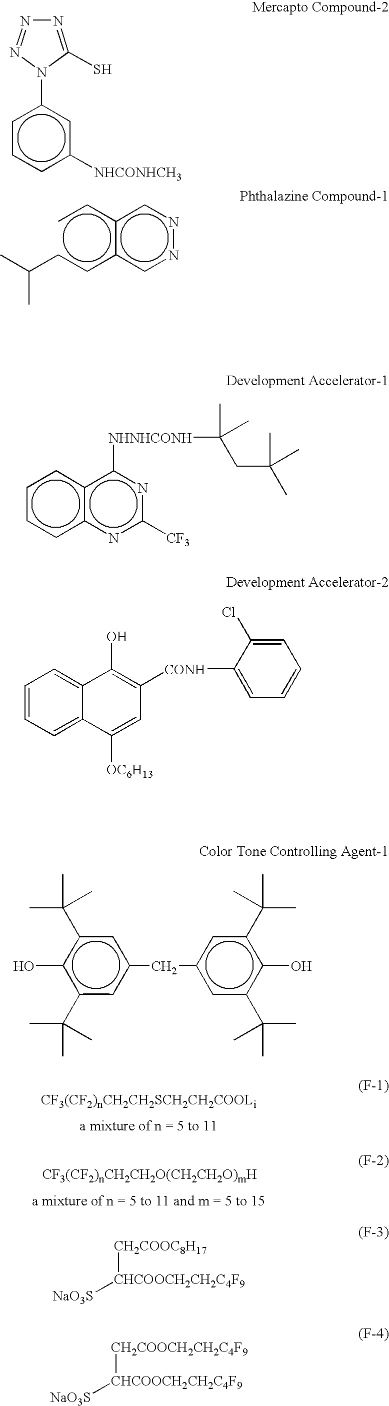
4. Evaluation of Photographic Performance
1) Preparation

The obtained samples were cut into a half size (24×12 inch sized sheet), packaged in an atmosphere of 25° C. and 50% RH, and evaluated for the following proprties after storage for 2 weeks at a normal temperature.

2) Packaging Material

50 μm polyethylene containing PET 10 μm/PE 12 μm/aluminum foil 9 μm/Ny 15 μm/carbon 3%, oxygen permeability: 0.02 ml/atm·m²·25° C.·day, moisture permeability: 0.10 g/atm·m²·25° C.·day.

3) Exposure and Development of Photosensitive Material

Photothermographic materials 1-5 were exposed to light and thermally developed using a Fuji medical dry laser imager-FM-DPL (mounting a 660 nm semiconductor laser having a maximum power of 60 mW (IIIB)) (modified, and light-exposed and develeoped for 21 sec in total using four sheets of panel heaters and controlled to 121° C.-121° C.-121° C.-121° C., or 117° C.-117° C.-117° C.-117° C.) to output half-solid images having 1.2 density. The thus obtained images were evaluated at a central area.

Photothermographic materials 6-10 were exposed to light and thermally developed using a laser imager described in Japanese Patent Application Nos. 2002-88832 and 2002-091114 (mounting a 660 nm semiconductor laser having a maximum power of 60 mW (IIIB)) (modified, and light-exposed and developed for 11 sec in total using three sheets of panel heaters modified and controlled to 121° C.-121° C.-121° C., or 117° C.-117° C.-117° C.).

As exposing conditions, the exposure amount was adjusted to obtain a density of 1.2 in respective development processings.

4) Evaluation Method and Result

4-1. Color Tone

Evaluation Method:

Color was measured using Spectrolino of Gretag Macbeth (manufactured by Macbeth Co.). Measurement was conducted using F5 as a light source for a measuring area of 3 mmφ and expressed by CIELa*b* in Table 1 below. Table 1 also shows the results of calculation via Expressions (1) to (4) based on the obtained data.
Value A: (a*₁₂₁ₜ−a*₁₁₇ₜ)²+(b*₁₂₁ₜ−b*₁₁₇ₜ)²
B: (a*₁₂₁ₜ−a*₁₂₁₍ₜ₋₃₎)²+(b*₁₂₁ₜ−b*₁₂₁₍ₜ₋₃₎)²
   Evaluation Result:

As seen from Table 1, comparative samples show a large value that is greater than 2 both in Value A and Value B, whereas all of the samples according to the present invention show a small value that is less than 2.

TABLE 1

| | Silver | | | | | | | | | |
|---|---|---|---|---|---|---|---|---|---|---|
| Sample | Behenate | | | | | | | | | |
| No. | Content | a*₁₂₁ₜ | a*₁₁₇ₜ | a*₁₂₁₍ₜ₋₃₎ | b*₁₂₁ₜ | b*₁₁₇ₜ | b*₁₂₁₍ₜ₋₃₎ | Value A | Value B | Remarks |
| 1 | 88 mol % | −2.2 | −1.5 | −1.2 | −7.3 | −8.4 | −8.7 | 2.08 | 2.96 | C.E. |
| 2 | 96 mol % | −2.2 | −1.6 | −1.0 | −7.3 | −8.6 | −8.9 | 2.5 | 4.0 | C.E. |
| 3 | 48 mol % | −2.2 | −2.1 | −2.1 | −7.3 | −7.6 | −7.9 | 0.1 | 0.37 | P.I. |
| 4 | 24 mol % | −2.2 | −2.2 | −2.1 | −7.3 | −7.8 | −8.4 | 0.25 | 1.22 | P.I. |
| 5 | 72 mol % | −2.2 | −2.0 | −2.0 | −7.3 | −8.0 | −8.1 | 0.53 | 0.68 | P.I. |
| 6 | 88 mol % | −2.1 | −1.3 | −1.0 | −7.3 | −8.5 | −8.9 | 2.08 | 3.77 | C.E. |
| 7 | 96 mol % | −2.1 | −1.2 | −0.9 | −7.3 | −8.8 | −9.1 | 3.37 | 4.68 | C.E. |
| 8 | 48 mol % | −2.1 | −2.0 | −2.1 | −7.3 | −7.6 | −7.9 | 0.1 | 0.36 | P.I. |
| 9 | 24 mol % | −2.1 | −2.1 | −2.0 | −7.3 | −7.9 | −8.5 | 0.36 | 1.45 | P.I. |
| 10 | 72 mol % | −2.1 | −1.9 | −2.0 | −7.3 | −8.1 | −8.2 | 0.68 | 0.82 | P.I. |

P.I.: Present Invention;
C.E.: Comparative Example

4-2. Evaluation and Result of Developing Ununiformity and Tone
Stability Upon Continuous Processing
Evaluation Method:
(Developing Ununiformity)

Photothermographic materials 1-10, cut into a half size, were arranged each by three sheets on a light table under 10,000 Lux, and images were outputted to obtain an image density of 1.2 under the conditions as described in (3) above and observed for sensorial evaluation. The obtained images were rated by the following criterai.
◯◯: no difference of tone was observed between each of three sheets
◯: slight difference of tone was observed between each of three sheets, with no trouble in reading images
Δ: difference of tone was observed between each of three sheets, with some difficulty in reading images
x: difference of tone was observed between each of three sheets, making reading impossible
   Continuous Processing Unevenness

Photothermographic materials 1-10, cut into a half size, were continuously processed for ten pieces of sheet, and images were outputted to give an density of 1.2 under the conditions as described in (3) above. First, fifth and tenth sheets were arranged and observed on a light table under 10,000 Lux to conduct sensorial evaluation. The obtained images were rated by the following criteria.
◯◯: no tone difference was observed between each of three sheets
◯: slight difference of tone was observed between each of three sheets, with no troubles in reading images
Δ: difference of tone was observed between each of three sheets, with some difficulty in reading images
x: difference of tone was observed between each of three sheets, making reading impossible
   Evaluation Result:

The evaluation results are summarized in Table 2 below. While developing ununiformity and continuous processing unevenness were severe in comparative samples, developing ununiformity was small in each of the samples according to the present invention. In particular, although remarkable unevenness was observed in samples 6, 7 that were developed for 11 sec, each of samples 8 to 10 according to the present invention was revealed good.

TABLE 2

| | Sample No. | | | | | | | | | |
|---|---|---|---|---|---|---|---|---|---|---|
| | 1 | 2 | 3 | 4 | 5 | 6 | 7 | 8 | 9 | 10 |
| Developing | Δ | x | ∘∘ | ∘ | ∘∘ | Δ | x | ∘∘ | ∘ | ∘∘ |
| Ununiformity | | | | | | | | | | |
| Continuous | Δ | x | ∘∘ | ∘ | ∘ | x | x | ∘∘ | ∘ | ∘ |
| Processing | | | | | | | | | | |
| Unevenness | | | | | | | | | | |

From the foregoing, when photothermographic materials which have Value A and Value B falling within a prescribed range in the tone evaluation were used, thermal developing ununiformity and continuous processing stability were significantly excellent.

As detailed above, the present invention provides a photothermographic material and an image forming method capable of providing images with no developing ununiformity and having stable tone.

1. A photothermographic material comprising a support having on one surface thereof a photosensitive silver halide, a non-photosensitive organic silver salt, a reducing agent and a binder, and satisfying a relationship of image tone defined by the following Expression (1):
(a*₁₂₁ₜ−a*₁₁₇ₜ)²+(b*₁₂₁ₜ−b*₁₁₇ₜ)²<2, (1)
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), said values occurring at an optical density of 1.2; and t represents a duration (sec) required to attain a maximum density when the material has been exposed to sufficient light for producing Dmax and is developed at 121° C.

2. The photothermographic material according to claim 1, which satisfies a relationship of image tone defined by the following Expression (2):
(a*₁₂₁ₜ−a*₁₁₇ₜ)²+(b*₁₂₁ₜ−b*₁₁₇ₜ)²<1.5, (2)
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), said values occurring at an optical density of 1.2; and t represents a duration (sec) required to attain a maximum density when the material has been exposed to sufficient light for producing Dmax and is developed at 121° C.

3. The photothermographic material according to claim 1, which satisfies a relationship of image tone defined by the following Expression (3):
(a*₁₂₁ₜ−a*₁₂₁₍ₜ₋₃₎)²+(b*₁₂₁ₜ−b*₁₂₁₍ₜ₋₃₎)²<2, (3)
wherein a*₁₂₁ₜ and b*₁₂₁ₜ each represent a value of CIELAB obtained by thermal development at a developing temperature of 121° C. for t (sec), and a*₁₂₁₍ₜ₋₃₎ and b*₁₂₁₍ₜ₋₃₎ each represent a value of CIELa*b* obtained by thermal development at a developing temperature of 121° C. for t−3 (sec), said values occurring at an optical density of 1.2; and t represents a duration (sec) required to attain a maximum density when the material has been exposed to sufficient light for producing Dmax and is developed at 121° C.

4. The photothermographic material according to claim 1, which satisfies a relationship of image tone defined by the following Expression (4):
(a*₁₂₁ₜ−a*₁₂₁₍ₜ₋₃₎)²+(b*₁₂₁ₜ−b*₁₂₁₍ₜ₋₃₎)²<1.5, (4)
wherein a*₁₂₁ₜ and b*₁₂₁ₜ each represent a value of CIELAB obtained by thermal development at a developing temperature of 121° C. for t (sec), and a*₁₂₁₍ₜ₋₃₎, and b*₁₂₁₍ₜ₋₃₎ each represent a value of CIELa*b* obtained by thermal development at a developing temperature of 121° C. for t−3 (sec), said values occurring at an optical density of 1.2; and t represents a duration (sec) required to attain a maximum density when the material has been exposed to sufficient light for producing Dmax and is developed at 121° C.

5. The photothermographic material according to claim 3, wherein all of the values for a*₁₂₁ₜ, b*₁₂₁ₜ, a*₁₁₇ₜ, b*₁₁₇ₜ, a*₁₂₁₍ₜ₋₃₎, and b*₁₂₁₍ₜ₋₃₎ are negative.

6. The photothermographic material according to claim 4, wherein all of the values for a*₁₂₁ₜ, b*₁₂₁ₜ, a*₁₁₇ₜ, b*₁₁₇ₜ, a*₁₂₁₍ₜ₋₃₎, and b*₁₂₁₍ₜ₋₃₎ are negative.

7. The photothermographic material according to claim 1, wherein a value for a*₁₂₁ₜ is −2 or less.

8. The photothermographic material according to claim 3, wherein a value for a*₁₂₁ₜ is −2 or less.

9. The photothermographic material according to claim 1, wherein the non-photosensitive organic silver salt has a silver behenate content of 35 to 85 mol %.

10. The photothermographic material according to claim 1, wherein the reducing agent is a hindered-type reducing agent or a bisphenol-type reducing agent.

11. The photothermographic material according to claim 3, wherein the reducing agent is a hindered-type reducing agent or a bisphenol-type reducing agent.

12. The photothermographic material according to claim 1, further comprising a development accelerator.

13. The photothermographic material according to claim 1, further comprising a hardening agent.

14. An image forming method comprising exposing a photothermographic material to light and carrying out thermal development to form an image, wherein the material comprises a support having on one surface thereof a photosensitive silver halide, a non-photosensitive organic silver salt, a reducing agent and a binder, and satisfies a relationship of image tone defined by the follwing Expression (1):
(a*₁₂₁ₜ−a*₁₁₇ₜ)²+(b*₁₂₁ₜ−b*₁₁₇ₜ)²<2, (1)
wherein a*₁₂₁ₜ and b*₁₂₁ₜ each represent a value of CIELa*b* obtained by thermal development at a developing temperature of 121° C. for t (sec), and a*₁₁₇ₜ and b*₁₁₇ₜ each represent a value of CIELAB obtained by thermal development at a developing temperature of 117° C. for t (sec), said values occurring at an optical density of 1.2; and t represents a duration (sec) required to attain a maximum density when the material has been exposed to sufficient light for producing Dmax and is developed at 121° C.

15. The image forming method according to claim 14, wherein a thermal developing duration is 15 sec or less.

16. The image forming method according to claim 15, wherein a thermal developing duration is 7 to 15 sec.

17. The image forming method according to claim 14, wherein light exposure is conducted by an He—Ne laser, a red semiconductor laser, an He—Cd laser or a blue semiconductor laser.

18. The image forming method according to claim 14, wherein thermal development is carried out at a temperature of 100 to 140° C.

19. The image forming method according to claim 14, wherein thermal development is carried out at a temperature of 110 to 130° C.

20. The image forming method according to claim 14, wherein thermal development is carried out using a drum-type heater or plate-type heater.
